(19) United States
(12) Patent Application Publication
(10) Pub. No.: US 2026/0079732 A1
(43) Pub. Date: Mar. 19, 2026

(54) CONTEXT-BASED EXECUTION OF A SOFTWARE ASSISTANT

(71) Applicant: Walkme LTD., Tel Aviv (IL)

(72) Inventors: Ron Zohar, Givatay'im (IL); Moran Shemer, Ra'anana (IL); Yasmin Selah, Rehovot (IL); Adam Rosenthal, Ra'anana (IL)

(21) Appl. No.: 18/889,517

(22) Filed: Sep. 19, 2024

(51) Int. Cl. G06F 9/451; G06F 40/30

(52) U.S. Cl. CPC G06F 9/453; G06F 40/30

(57) ABSTRACT

A method, apparatus, and product for configuring a software assistant, the software assistant is executed over a third-party application, comprising: defining an identification event associated with a Graphical User Interface (GUI) of the third-party application; defining that, in response to an occurrence of the identification event, a launcher associated with an automation process is configured to be presented in the software assistant over the GUI; defining source data associated with the automation process, wherein the automation process is configured to process the source data; configuring the software assistant to automatically execute the automatic process in response to an occurrence of a trigger event associated with the launcher, thereby processing the source data and outputting a result; and defining a configuration for presenting an output in the GUI, the output is determined based on the result of the automation process.

### TECHNICAL FIELD

The present disclosure relates to a software assistant in general, and to a context-based execution of a software assistance, in particular.

### BACKGROUND

A software assistance such as a software copilot may comprise an AI-powered engine offering guidance, suggestions, and assistance to users in various digital realms. In some cases, a software copilot may be designed to leverage AI language models, such as Large Language Models (LLMs), to engage in natural language conversations with end users and interpret their natural language commands to perform digital tasks or provide information.

Advancements in artificial intelligence and natural language processing have led to the development of sophisticated models capable of understanding, generating, and processing human language at an unprecedented scale. For example, a language model such as a LLM constitutes an advanced machine learning model trained on vast amounts of textual data, enabling it to comprehend and generate human-like text in a variety of languages. These models employ deep neural network architectures to learn patterns, semantics, and contextual information from textual inputs, enabling them to perform tasks such as language translation, text summarization, sentiment analysis, and even creative writing. Several notable examples of publicly available LLM products are ChatGPT™, BARD™ and BING™ Chat.

### BRIEF SUMMARY

One exemplary embodiment of the disclosed subject matter is a method for configuring a software assistant, the software assistant is configured to be executed as an overlay over a third-party application, the third-party application is executable on a plurality of end devices of end users, the method comprising: defining an identification event associated with a Graphical User Interface (GUI) of the third-party application, the identification event is defined based on one or more conditions associated with a page context of the GUI; defining that, in response to an occurrence of the identification event, a launcher associated with an automation process is configured to be automatically presented in the software assistant over the GUI; defining source data associated with the automation process, the source data comprising at least a portion of text presented in the GUI, wherein the automation process is configured to process the source data; configuring the software assistant to, in response to an occurrence of a trigger event associated with the launcher, automatically execute the automatic process, the automatic process is configured to process the source data and output a result; and defining a configuration for presenting an output in the GUI, the output is determined based on the result of the automation process.

Optionally, the automation process comprises: automatically generating a prompt for an Artificial Intelligence (AI) engine, wherein the prompt is generated to comprise a predefined structure of a static portion and a dynamic portion, wherein the dynamic portion is configured to be populated with the source data every invocation of the trigger event; providing the prompt to the AI engine; and obtaining the result from the AI engine based on the prompt, wherein the output is determined based on the result from the AI engine.

Optionally, the automation process is configured to be executed with respect to a content source, wherein the content source comprises a database or a repository, wherein the prompt to the AI engine is determined to be generated at least in part based on retrieved data that is retrieved from the content source.

Optionally, the AI engine comprises a Large Language Model (LLM) or a Small Language Model (SLM).

Optionally, the page context comprises at least one of: an element in the GUI; an address of a page rendering the GUI; a user segment of an end user; the text in the GUI; a user interaction with the text presented in the GUI; and one or more properties of the GUI.

Optionally, the one or more properties comprise a first property of a first GUI element in the GUI, and a second property of a second GUI element in the GUI, wherein the one or more conditions define a logical relationship between the first and second properties.

Optionally, the address of the page comprises a Uniform Resource Locator (URL).

Optionally, the method further comprises determining compliance with the one or more conditions of the identification event based on a second automation process, said determining the compliance comprising: automatically processing the text by an execution of the second automation process; based on said automatically processing, determining whether the text complies with the one or more conditions; and presenting the launcher in the software assistant based on said determining that the text complies with the one or more conditions.

Optionally, the compliance is determined based on a semantic analysis of the text, wherein the semantic analysis of the text is performed, as part of the second automation process, using a language model.

Optionally, the one or more conditions require that the GUI represents a specific form, wherein the semantic analysis is configured to determine whether the GUI represents the specific form.

Optionally, the method further comprises removing the launcher from the software assistant, in response to a determination that the GUI of the third-party application no longer complies with the one or more conditions of the identification event.

Optionally, the launcher comprises a GUI control, wherein the trigger event associated with the launcher comprises a user interaction with the GUI control when presented in a bar of the software assistant.

Optionally, the source data comprises at least one of: text associated to at least one element that is rendered in the GUI; selected text in the GUI and is selected by an end user; and all text that is rendered in the GUI.

Optionally, the source data comprises text associated to the at least one element, wherein the launcher and the output are not presented adjacently to the at least one element.

Optionally, the software assistant is configured to present a second launcher over the GUI in response to the identification event, the second launcher defines a second automation process different than the first automation process.

Optionally, the method further comprises defining a second identification event configured to cause a second launcher to be displayed within a bar of the software assistant, the second identification event different from the identification event; defining second source data for the second launcher; configuring the software assistant to present the second launcher within the bar in response to the second identification event; and configuring the software assistant to, in response to a second trigger event of the second launcher, execute a second automation process, wherein an execution of the second automation process processes the second source data and outputs a second result, the second automation process is different from the automation process.

Optionally, the software assistant is a copilot, the copilot configured to present a chat widget as part of a natural language conversation with the end user, the copilot configured to present a bar widget with one or more launchers in response to one or more identification events, respectively, the one or more identification events comprise at least the identification event.

Optionally, the bar widget is configured to be visible for a defined timeframe after the occurrence of the identification event, wherein the bar widget is configured to become invisible after the defined timeframe.

Optionally, the configuration for presenting the output comprises presenting the output via the chat widget of the copilot.

Optionally, the method further comprises configuring the software assistant to, in response to the occurrence of the trigger event, automatically execute a plurality of automatic processes that are configured to process a respective plurality of data sources from the text, thereby obtaining a respective plurality of outputs.

Optionally, the method further comprises defining a second configuration for presenting the plurality of outputs in the GUI, wherein the second configuration comprises presenting a set of tags in a window overlay, the window overlay is overlayed over the third-party application, each tag corresponding to a respective automation process from the plurality of automatic processes, wherein the window overlay is configured to present, for a tag, a generated output of a respective automation process of the tag, wherein the generated output is configured to be presented together with the tag in a separate section of the window overlay, or in an output section of the window overlay in response to a selection of the tag from the set of tags.

Optionally, the window overlay is configured to depict a highlight control for the tag, wherein selecting the highlight control causes a data source of the tag to be highlighted in the GUI.

Optionally, the output is the result of the automation process.

Optionally, there is no Application Programming Interface (API) between the software assistant and the third-party application, wherein the software assistant is configured to identify the identification event by monitoring and analyzing the GUI of the third-party application as rendered on an end device of the plurality of end devices.

Optionally, said configuring the software assistant is performed by an administrator user using a digital adoption platform, the digital adoption platform is agnostic to the third-party application, wherein the digital adoption platform is configured to assist the end users with performing digital tasks on the third-party application.

Another exemplary embodiment of the disclosed subject matter is an apparatus comprising a processor and memory, the processor adapted to configure a software assistant, the software assistant is configured to be executed as an overlay over a third-party application, the third-party application is executable on a plurality of end devices of end users, the processor is adapted to: define an identification event associated with a GUI of the third-party application, the identification event is defined based on one or more conditions associated with a page context of the GUI; define that, in response to an occurrence of the identification event, a launcher associated with an automation process is configured to be automatically presented in the software assistant over the GUI; define source data associated with the automation process, the source data comprising at least a portion of text presented in the GUI, wherein the automation process is configured to process the source data; configure the software assistant to, in response to an occurrence of a trigger event associated with the launcher, automatically execute the automatic process, the automatic process is configured to process the source data and output a result; and defining a configuration for presenting an output in the GUI, the output is determined based on the result of the automation process.

Yet another exemplary embodiment of the disclosed subject matter is a computer program product comprising a non-transitory computer readable storage medium retaining program instructions, which program instructions, when read by a processor, cause the processor to configure a software assistant, the software assistant is configured to be executed as an overlay over a third-party application, the third-party application is executable on a plurality of end devices of end users, wherein the program instructions, when read by the processor, cause the processor to: define an identification event associated with a GUI of the third-party application, the identification event is defined based on one or more conditions associated with a page context of the GUI; define that, in response to an occurrence of the identification event, a launcher associated with an automation process is configured to be automatically presented in the software assistant over the GUI; define source data associated with the automation process, the source data comprising at least a portion of text presented in the GUI, wherein the automation process is configured to process the source data; configure the software assistant to, in response to an occurrence of a trigger event associated with the launcher, automatically execute the automatic process, the automatic process is configured to process the source data and output a result; and defining a configuration for presenting an output in the GUI, the output is determined based on the result of the automation process.

One exemplary embodiment of the disclosed subject matter is a method comprising: assisting an end user with performing a digital task associated with a GUI of a third-party application, the end user is executing the third-party application on an end device, said assisting comprises: executing an assistance layer on the end device, the assistance layer comprises a software assistant; presenting a launcher in a bar widget of the software assistant, said presenting is performed in response to the assistance layer detecting an occurrence of an identification event in the GUI; executing an automation process of the launcher on the end device, said executing the automation process is performed in response to identifying an interaction of the end user with the launcher via the bar widget; and presenting an output over the GUI to the end user, the output is determined based on a result from the automation process, the output is presented in a chat widget of the software assistant.

Optionally, the automation process comprises: automatically generating a prompt for an AI engine; providing the prompt to the AI engine; and obtaining the result from the AI engine based on the prompt, wherein the output is determined based on the result from the AI engine.

Optionally, the automation process is configured to be executed with respect to a content source, wherein the content source comprises a database or a repository, wherein the prompt to the AI engine is determined to be generated at least in part based on retrieved data that is retrieved from the content source.

Optionally, the AI engine comprises a LLM or a SLM.

Optionally, the software assistant is configured to present a second launcher over the GUI in response to the identification event, the second launcher defines a second automation process different than the first automation process.

Optionally, the software assistant is a copilot, the copilot configured to present a chat widget as part of a natural language conversation with the end user, the copilot configured to present one or more launchers in the bar widget in response to one or more identification events, respectively, the one or more identification events comprise at least the identification event.

Optionally, the bar widget is configured to be visible for a defined timeframe after the occurrence of the identification event, wherein the bar widget is configured to become invisible after the defined timeframe.

Optionally, the output is the result of the automation process.

Optionally, there is no API between the software assistant and the third-party application, wherein the software assistant is configured to identify the identification event by monitoring and analyzing the GUI of the third-party application as rendered on the end device.

Optionally, the software assistant is configured by an administrator user using a digital adoption platform, the digital adoption platform is agnostic to the third-party application, wherein the digital adoption platform is configured to assist the end user with performing digital tasks on the third-party application.

Another exemplary embodiment of the disclosed subject matter is an apparatus comprising a processor and memory, the processor adapted to: assist an end user with performing a digital task associated with a GUI of a third-party application, the end user is executing the third-party application on an end device, said assisting comprises: executing an assistance layer on the end device, the assistance layer comprises a software assistant; presenting a launcher in a bar widget of the software assistant, said presenting is performed in response to the assistance layer detecting an occurrence of an identification event in the GUI; executing an automation process of the launcher on the end device, said executing the automation process is performed in response to identifying an interaction of the end user with the launcher via the bar widget; and presenting an output over the GUI to the end user, the output is determined based on a result from the automation process, the output is presented in a chat widget of the software assistant.

Yet another exemplary embodiment of the disclosed subject matter is a computer program product comprising a non-transitory computer readable storage medium retaining program instructions, which program instructions when read by a processor, cause the processor to: assist an end user with performing a digital task associated with a GUI of a third-party application, the end user is executing the third-party application on an end device, said assisting comprises: executing an assistance layer on the end device, the assistance layer comprises a software assistant; presenting a launcher in a bar widget of the software assistant, said presenting is performed in response to the assistance layer detecting an occurrence of an identification event in the GUI; executing an automation process of the launcher on the end device, said executing the automation process is performed in response to identifying an interaction of the end user with the launcher via the bar widget; and presenting an output over the GUI to the end user, the output is determined based on a result from the automation process, the output is presented in a chat widget of the software assistant.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1B show flowchart diagrams of methods, in accordance with some exemplary embodiments of the disclosed subject matter;

FIGS. 2A-2E depict exemplary user interactions with a deployed software assistance, in accordance with some exemplary embodiments of the disclosed subject matter;

FIGS. 3A-3B depict an exemplary execution of a deployed software assistant, in accordance with some exemplary embodiments of the disclosed subject matter;

FIGS. 4A-4C depict an exemplary execution of a deployed software assistant, in accordance with some exemplary embodiments of the disclosed subject matter;

FIG. 5 shows an exemplary execution of a deployed software assistant, in accordance with some exemplary embodiments of the disclosed subject matter;

FIGS. 6A-6F depict an exemplary DAP editor, in accordance with some exemplary embodiments of the disclosed subject matter; and

FIG. 7 shows a schematic illustration of an exemplary environment in which the disclosed subject matter may be utilized, in accordance with some exemplary embodiments of the disclosed subject matter.

### DETAILED DESCRIPTION

One technical problem dealt with by the disclosed subject matter is to aid human users in performing digital tasks. In some exemplary embodiments, digital tasks may comprise actions or activities that users perform using digital devices or platforms. Digital tasks may vary in complexity and purpose, encompassing a broad spectrum of actions conducted in the digital realm. In some cases, performing digital tasks may encompass several operations, such as navigating a website, clicking on links, accessing different pages, using search functionalities, or the like. For example, a digital task may comprise creating digital content such as documents, presentations, images, videos, or the like, editing digital content, filling out text fields, submitting personal information, communicating with other instances or systems, communicating with other users using digital infrastructure, extracting data, executing software applications, reviewing support tickets, a combination thereof, or the like In some cases, performing digital tasks may encompass a submission of data, text, or the like, such as via digital forms, web-based forms, or the like, into designated third-party systems, websites, applications, or the like. In some exemplary embodiments, digital tasks may be performed via a digital platform, such as a software application, a desktop application, a web-based application, an operating system, a Software as a Service (SaaS) application, or the like. It may be desired to assist end users with completing digital tasks efficiently, properly, successfully, in a timely manner, or the like.

Another technical problem dealt with by the disclosed subject matter is to assist users with content-related processes of digital tasks, e.g., in real time. For example, it may be desired to aid users with content-related processes such as analyzing submitted data, generating responses to submitted data, or with similar scenarios. In many cases, performing content-based assistance may be challenging.

Yet another technical problem dealt with by the disclosed subject matter is to actively and automatically assist users with digital tasks. For example, in order to enhance the user experience, it may be desired to provide users with a “push experience” in which assistance is actively delivered or pushed to the user without explicit action on the user's part. For example, a “push experience” may enhance the user experience by reducing cognitive load, minimizing the number of user actions required to obtain services, increasing interactivity, and providing better contextual support, and thus may be desired.

Yet another technical problem dealt with by the disclosed subject matter is to enhance a performance of a software assistance such as a copilot. In some exemplary embodiments, a copilot may comprise an Artificial Intelligence (AI)-powered engine offering guidance, suggestions, and assistance to users in various digital domains. In some cases, the software copilot may be designed to leverage AI language models, such as Large Language Models (LLMs), Small Language Models (SLMs), or the like, to engage in natural language conversations with end users and interpret their natural language commands to perform tasks or provide information. It is noted that throughout the disclosure, any reference to LLMs or LLM engines is not restricted to Generative Pre-trained Transformers (GPTs)-based models and may refer to any other AI engine, SLM, or similar technologies.

In some exemplary embodiments, software copilots may be designed in association with a web browser, and may be configured to be executed over the browser. For example, a software copilot may be hosted by a browser, e.g., as a browser extension, a Hypertext Markup Language (HTML) code or file embedded in the browser, or the like. In some cases, software copilots may be executed over a single domain, e.g., a single page and tab of the browser, or over multiple domains. In some exemplary embodiments, software copilots may be typically presented as a separate page positioned adjacently to a browsed page rendered by the browser.

In some exemplary embodiments, software copilots may have one or more drawbacks. For example, they may require active engagement of the user, requiring the user to access the chat with the copilot (e.g., by navigating to the copilot chat), converse with the Natural Language Processing (NLP) engine of the copilot, and attempt to extract desired outputs through the conversation, which may not always be easy or satisfactory. It may be desired to enhance this user experience, and to provide a copilot with a “push experience” that reduces required user engagement, reduces cognitive load, increases interactivity, and provides better contextual support.

One technical solution provided by the disclosed subject matter may be to combine the copilot engine and interface with capabilities of one or more platforms such as a Digital Adoption Platform (DAP). For example, DAP capabilities may be leveraged by a software assistance, e.g., a copilot, to provide users with contextual assistance in real time, as a push experience.

In some exemplary embodiments, a DAP may be a comprehensive software platform designed to assist end users with digital tasks such as to navigate and interact with digital assets. For example, a DAP may be used to facilitate and streamline the adoption and usage of digital tools, applications, and software systems within organizations, such as by providing interactive guidance, contextual assistance, or the like. In some exemplary embodiments, a DAP may enable to generate an assistance layer that can be executed over a third-party system, and assist users of the third-party system with performing digital tasks. For example, the third-party system may be separate from the DAP, may not collaborate therewith, may not perform Application Programming Interface (API) calls to one another, or the like, and may comprise any software products, applications, or websites.

In some exemplary embodiments, a DAP may be used by administrator (admin) users of an organization as a software platform designed to facilitate and streamline the adoption and usage of digital tools, applications, and software systems within the organization. For example, admin users may define an assistance layer such as a walkthrough for a third-party application through the DAP, and the walkthrough may be distributed to end users of the third-party application. In some exemplary embodiments, in addition to generating assistance layers, a DAP may enable admin users to perform one or more statistical analyses, identify patterns of end user interactions with a digital asset, identify patterns of end user interactions with a deployed assistance layer, or the like. For example, based on statistical analyses of user performance when using a DAP-based walkthrough, admin users may extract insights useful for revising the walkthrough, enhancing portions thereof, or the like.

In some exemplary embodiments, an assistance layer may be designed by admin users via an editor of a DAP, which may be a no-code platform enabling non-programmers to define, using a simple user interface, an assistance layer with automations, rules, or the like. In some exemplary embodiments, the no-code platform may not require the admin user to provide or amend any coding. For example, the editor may provide preconfigured building blocks, which may be selected and configured by the admin user in order to generate an assistance layer. In some exemplary embodiments, an assistance layer generated by an admin user may be executable over end devices of end users. In some cases, the assistance layer may be designed to be used by end users such as employees of an organization, customers of the organization, users browsing the web, or any other population segment. In some cases, the end devices may execute one or more third-party software applications, and execute the assistance layer thereover.

In some exemplary embodiments, DAP building blocks provided by the DAP editor may comprise widgets such as launcher widgets, buttons, tooltips, chat widgets, balloon layouts, or any other Graphical User Interface (GUI) controls, which may be utilized by an administrator user for designing an assistance layer that is configured to assist end users with digital tasks over a software application. In some exemplary embodiments, DAP building blocks may be configured using rules, heuristics, conditions, branches, or the like. For example, a rule may define that upon acquiring a specified element in the GUI, a walkthrough step with specified text should be presented over the GUI, at a defined position. In some exemplary embodiments, by selecting and configuring DAP building blocks available in the editor, an administrator user may generate an assistance layer comprising selected types of building blocks, defined positions for each DAP building block over the pages or layouts of a third-party application, selected automation processes that are linked to each DAP building block, selected trigger events that invoke or activate each automation process, or the like. For example, the administrator user may design and generate the assistance layer over the SALESFORCE® application, or any other application, in order to aid users from his organization with performing digital tasks over the application.

In some exemplary embodiments, admin users may be enabled to design assistance layers to help end users complete digital tasks, leverage new features, overcome obstacles, or the like. For example, an admin user may design, via the DAP interface, a launcher widget (also referred to as “launcher”) configured to trigger predefined content presentations. As another example, an admin user may design, via the DAP, custom tooltips (or “ShoutOuts”) that are configured to draw end-user's attention to a featured text or element, in order to assist end users with understanding the element's functionality or significance. As another example, an admin user may design, via the DAP, one or more tooltips configured to appear when an end user hovers their cursor over a specified element such as a button, icon, or link, and to provide supplementary information about the purpose or function of the associated element.

In some exemplary embodiments, widgets such as launchers may comprise interactive GUI elements that may be configured to present data to users, to enables users to activate an automation process, or the like. In some exemplary embodiments, a launcher may comprise an interactive widget that is configured to perform an operation in response to a user interaction, to a defined event, or the like. For example, in response to a user selection of a launcher, an operation may be performed, e.g., executing a walkthrough, presenting a tooltip widget, presenting chat widgets, presenting balloon layouts, or the like. In some exemplary embodiments, all properties of launchers may be defined and set via the editor, e.g., by selecting its automation process, presentation, or the like.

In some exemplary embodiments, a defined assistance layer may be distributed or made accessible to a plurality of end devices. In some exemplary embodiments, the execution of the assistance layer on an end device may cause one or more overlays to be presented over at least one third-party application. In some cases, the execution of the assistance layer may cause layout adaptations that may be performed within a GUI, e.g., instead or in addition to one or more overlays.

In some exemplary embodiments, additional aspects of digital adoption platforms are described, inter alia, in U.S. Pat. No. 9,922,008, entitled “Calling-Scripts Based Tutorials”, dated Mar. 20, 2018, U.S. Pat. No. 9,934,782, entitled “Automatic Performance Of User Interaction Operations On A Computing Device”, dated Apr. 3, 2018, U.S. Pat. No. 10,819,664 “Chat-Based Application Interface For Automation”, dated Oct. 27, 2020, U.S. Pat. No. 10,620,975, entitled “GUI Element Acquisition Using A Plurality Of Alternative Representations Of The GUI Element”, dated Apr. 14, 2020, and U.S. Pat. No. 10,713,068, entitled “Acquisition Process Of GUI Elements Using User Input”, dated Jul. 14, 2020, all of which are hereby incorporated by reference in their entirety for all purposes without giving rise to disavowment.

In some exemplary embodiments, in order to adjust a software assistant such as a copilot to provide contextual support, to have increased interactivity, ease of use, or the like, the software copilot may be designed to leverage capabilities of DAP building blocks to provide contextual assistance, automation, and proactive suggestions.

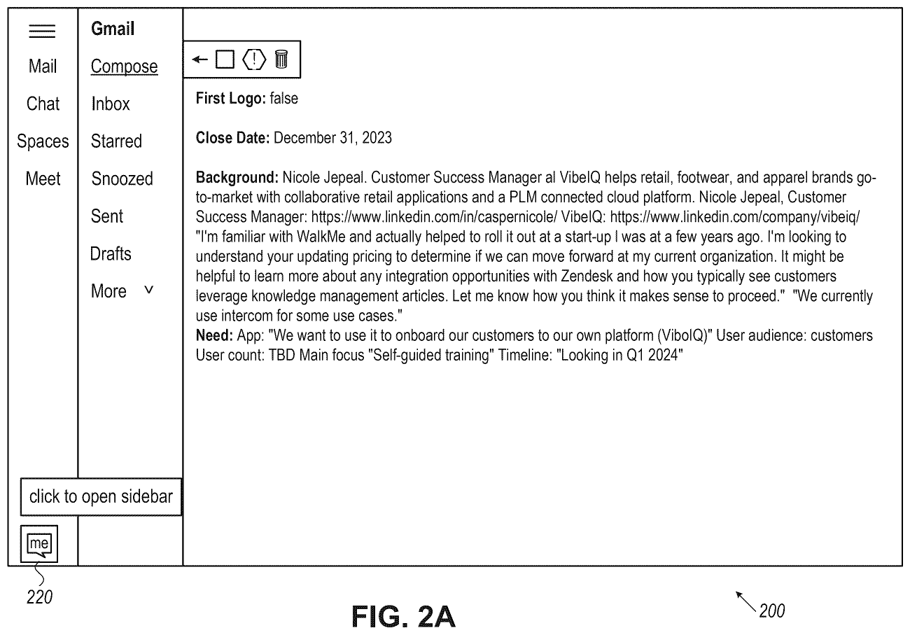

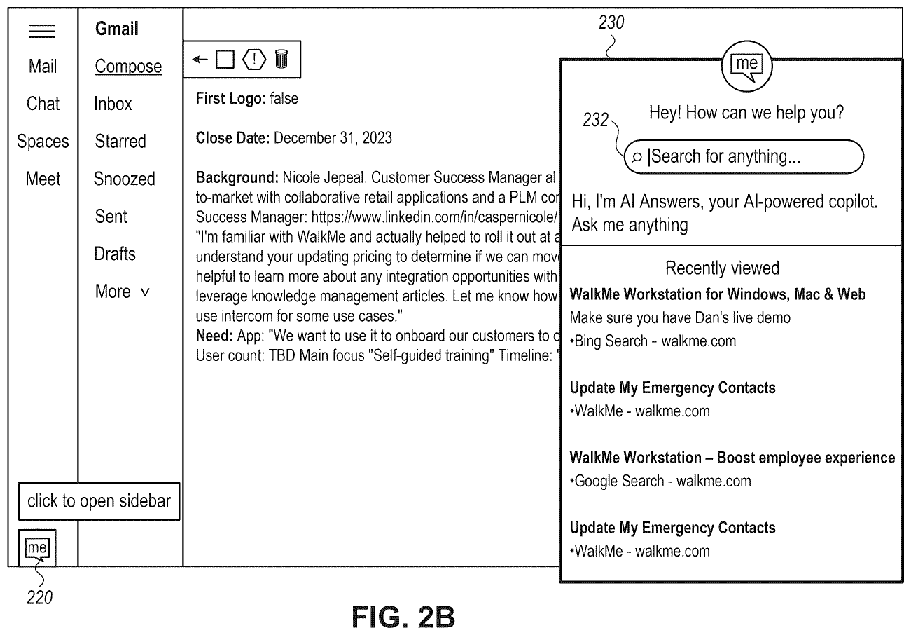

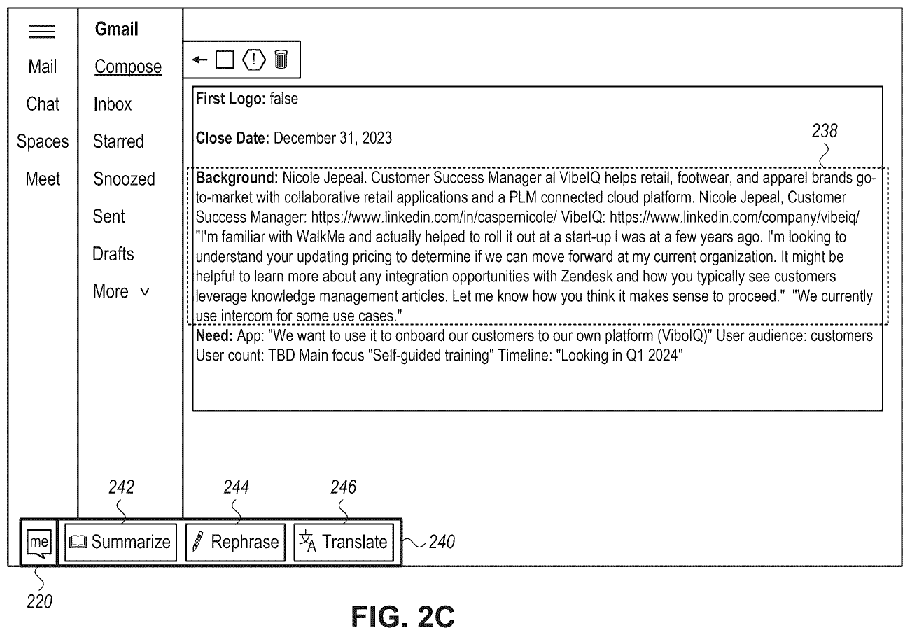

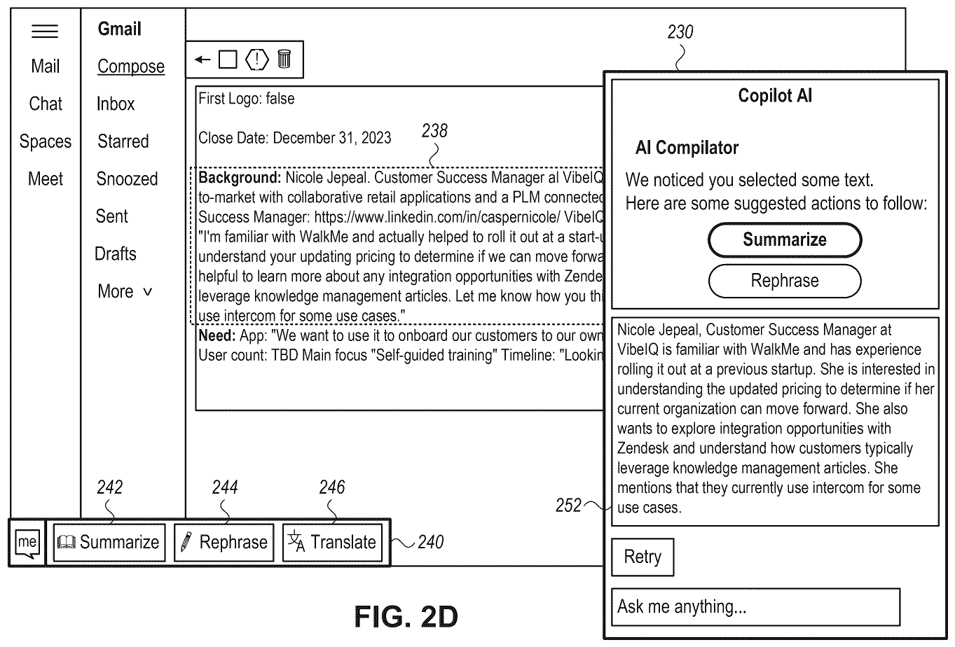

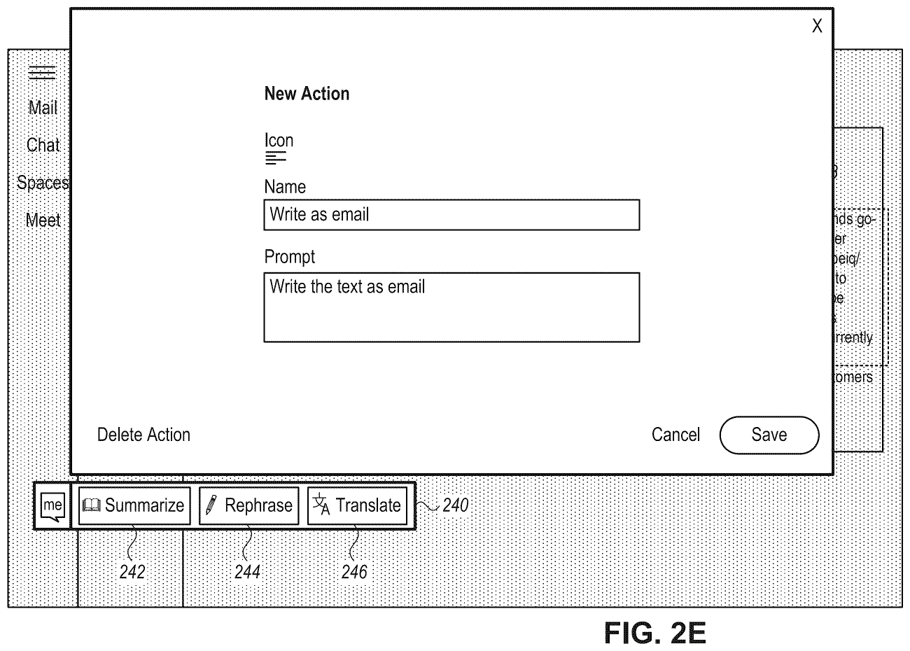

In some exemplary embodiments, the software copilot may be configured to present, over a GUI of an end device, a chat widget, enabling end users to engage in a natural language conversation with the copilot engine, e.g., using NLP processing. For example, the chat widget may become visible in response to a user interaction such as a selection of a dedicated widget, e.g., as depicted in FIG. 2A. In some cases, the chat widget may be rendered an overlay over the GUI of the third-party application, instead of as a separate page, thereby enhancing the interactivity of the copilot.

In some exemplary embodiments, the software copilot may be adjusted to present, in addition to the chat widget, a bar widget with DAP building blocks such as launchers. In some exemplary embodiments, the bar widget may refer to any bar, toolbar, window, container, or the like, presented as an overlay over the GUI of the third-party application.

In some exemplary embodiments, using DAP building blocks, the bar widget may be designed to incorporate a set of one or more launchers (or any other type of widget), which may be configured to provide context-based automation processes to the end users. For example, the bar widget, also referred to as ‘copilot bar’ or ‘bar’, may constitute a container of launchers and/or any other widgets. In some exemplary embodiments, the bar widget may be rendered invisibly over pages of the third-party application, and may be rendered visible based on a contextual analysis of the pages. In some cases, the bar widget may remain visible at all times, and launchers therein may be presented and rendered visible according to a contextual analysis.

In some exemplary embodiments, the properties of the chat widget, the bar widget, or the like, mat be set by an admin user via the DAP editor. In some exemplary embodiments, the DAP editor may be adjusted to incorporate (e.g., as DAP building blocks) one or more engines of copilots, visual configurations of copilots, chat widgets thereof, bar widgets thereof, launchers for the bar widget, interfaces with copilot engines, or the like.

In some exemplary embodiments, in contrast to the chat widget of the copilot, which requires active participation of the end users in a free text natural language chat to obtain desired digital services, the bar widget of the copilot may provide end users with a push experience with contextual support, without requiring user activations, natural language instructions from end users, or the like. For example, a context of a rendered page may be analyzed automatically by an assistance layer that constitutes at least of copilot launchers, and based on the contextual analysis, one or more launchers may be presented to the users in the bar widget of the copilot. In some exemplary embodiments, the launchers may enable the end users to obtain contextual assistance with digital tasks, by merely interacting or selecting a launcher of interest, to perform a respective digital task. In some cases, the launchers may offer services and assistance that the end user may not have considered, that the end user lacks the energy to request from the copilot through a conversation, or the like, thereby enhancing the user-machine interaction and the user experience.

In some exemplary embodiments, launchers may be retrieved and presented in the bar widget of the co-pilot based on a context of the page, a category of the user, an organization of the user, a user segment that corresponds to the user, or the like. For example, a launcher associated with an automation process may be configured to be presented in case that the GUI of the third-party application matches a defined condition, and in case the user belongs to a defined segment, resulting with two end users being presented with different launchers while rendering the same page content of the third-party application. In some cases, the context of the page may refer to any other condition associated with the GUI of the third-party application, e.g., a condition associated with the entire page, a condition associated with an element within the page, a condition associated with user interactions with the GUI, or the like.

In some exemplary embodiments, the conditions for presenting a launcher may be referred to as identification events. In some exemplary embodiments, identification events may be defined to occur when a GUI of the third-party application complies with context-based rules relating to a URL of the rendered page complying with one or more conditions, an on-screen element complying with one or more conditions, a jQuery element complying with one or more conditions, user data provided by the user complying with one or more conditions, or the like.

For example, in response to an identification event relating a selection of text by the end user, the copilot bar may display launchers that are defined with such an identification event. According to this example, context-based launchers may be presented such as a ‘summarize’ launcher for summarizing the selected text, a ‘translate’ launcher for translating the selected text, a ‘rephrase’ launcher for rephrasing the selected text, a ‘spellcheck’ launcher for checking the spelling of the selected text, an ‘explaining’ launcher for explaining the selected text, or the like.

In some exemplary embodiments, identification events may be configured to be continuously monitored, periodically monitored, to be monitored in response to a defined condition, or the like. For example, an identification event may comprise detecting user input to a GUI element, detecting that text in the displayed GUI complies with one or more conditions, detecting that a specified element is visible or invisible in the GUI, detecting that a specified Uniform Resource Locator (URL) is loaded, detecting that a statistical analysis of the page complies with a condition, determining that specified text in the GUI corresponds with one or more conditions, or the like.

In some exemplary embodiments, after an identification event of a launcher is identified, the launcher may be presented in the bar widget. In some exemplary embodiments, displayed launchers may be defined to execute one or more automation processes in response to one or more trigger events. For example, in response to a user interaction with a launcher, an automation process of the launcher may be performed, invoked, executed, or the like. For example, the automation process may be configured to generate text based on a page element in the GUI, hide parts of the GUI, change a layout of the GUI, generating text based on selected text in the GUI, or the like.

In some cases, launchers may be defined to present one or more outputs from the automation process to the end user. For example, the selection of the launcher by an end user may be presented as a message in the chat widget of the copilot, and the output from the automation process may be presented as a response message from the copilot's engine in the chat widget. In other cases, the output may be presented in any other widget, e.g., in a window, a tooltip, a balloon layout, a WhatsApp™ chat widget, or the like.

In some cases, the bar widget may be remain visible at all times, or may be rendered invisible, until one or more events or operations are performed. For example, upon detecting that an identification event of a launcher occurred, the launcher may be determined to be presented in the bar widget, rendering the bar widget visible. According to this example, the bar widget may be made visible without requiring user input. As another example, in case the bar widget displays one or more launchers, and determines that the identification events of the launchers are not relevant in the current GUI or context, the bar widget may be rendered invisible, until at least one launcher is determined to be presented thereby.

In some exemplary embodiments, the visibility of the bar widget may be based on one or more timeouts. In some exemplary embodiments, in case one or more identification events are identified, the bar widget may become visible for a defined timeframe, after which the widget may be rendered invisible. In some exemplary embodiments, after the copilot bar is presented for a duration of the timeframe, the copilot bar may be rendered invisible, and may become visible again if an identification event is detected. For example, after a first identification event is detected, the bar may be visible for a timeframe, and may become invisible after the timeframe elapsed without a user interaction with the bar widget. The bar may become visible again after a second identification event is detected. According to this example, the second appearance of the bar may include an additional launcher, e.g., a launcher associated with the second identification event. For both identification events, the launchers may be presented in a same location, within the bar widget, regardless of any page elements associated to the launchers.

In some exemplary embodiments, in case the bar widget is displayed, is visible, or the like, the user may be enabled to interact with the bar widget, e.g., to select a launcher from the bar widget. In some exemplary embodiments, interactions with the bar widget may pause the timeout, causing the bar widget to stay visible until the corresponding automation process is executed and its result is presented.

In some exemplary embodiments, the launchers may be positioned in the bar widget, which may be a constant location that is independent from positions of elements in the GUI.

In some cases, the bar widget may manifest as a side bar, a top bar, a bottom bar, or similar variant, and users may have the option to reposition it over the GUI. For example, users may be enabled to drag the bar widget to their preferred side of the display. In some cases, the user may be enabled to customize aspects of the bar widget such as the size of the copilot bar, its color scheme (dark or light mode), or the like.

In some cases, one or more launchers may comprise an automation process that utilizes LLM technology. In some exemplary embodiments, instead of configuring a behavior of launchers only according to heuristics, predetermined rules, or the like, at least some launchers defined by the copilot may be designed to perform an operation in cooperation with an AI language model such as an LLM. For example, LLM infrastructure may be exploited for assisting end users with digital tasks.

In some exemplary embodiments, LLM infrastructure may be exploited via the software assistant, e.g., by utilizing the chat widget of the copilot. For example, a launcher may interface with an LLM engine of the copilot directly via the chat widget or indirectly via API calls, invisible chats, or the like. In other cases, any LLM infrastructure may be exploited. In some exemplary embodiments, launchers may exploit LLM infrastructure in any other way, e.g., by applying a thin wrapper around an LLM engine.

In some exemplary embodiments, a language model such as an LLM of the copilot engine may comprise a private LLM, a public LLM such as public Generative Pre-trained Transformers (GPTs), a public LLM that is retrained on a private dataset such as an internal knowledge base, an on premise LLM, or the like. In some exemplary embodiments, launchers may utilize any other engines or infrastructure, such as Natural Language Processing (NLP) models, different Machine Learning (ML) models, AI models, generative AI models, or the like. For example, in response to an identified occurrence of a trigger event (e.g., a selection of the launcher via the bar widget), an LLM-based automation process may be performed, e.g., as disclosed in U.S. patent application Ser. No. 18/661,229, entitled “Defining Widgets And Executing Them Over An Application”, filed May 10, 2024, which is hereby incorporated by reference in its entirety for all purposes without giving rise to disavowment.

In some exemplary embodiments, in case automation processes of launchers collaborate with an LLM engine (e.g., via the chat widget of the copilot), they may be designed to generate one or more prompts to the engine. In some exemplary embodiments, the prompts may prompt the LLMs to implement an operation, digital task, process, or the like, as part of an automation process, a portion of the automation process, or the like. In some exemplary embodiments, an LLM session may be invoked by generating a prompt and communicating the prompt to an LLM engine. For example, LLM infrastructure, such as the LLM engine of the copilot, may be configured to provide feedback to a user's input, suggest revisions to a user's input, assist users with analyzing text, assist users with generating text, or the like. In some exemplary embodiments, the capabilities of the LLMs may be exploited for performing content-related tasks, semantic analyses, or the like, thereby increasing the capabilities of copilot's launcher, increasing a number of available automation processes for launchers provided by a digital adaptation platform, or the like.

In some exemplary embodiments, instead of exploiting LLM capabilities in an unrestricted manner, LLMs may be utilized by copilots under restricted frameworks. For example, LLMs may be provided with predefined prompt structures, predefined text portions, or the like, and may be utilized only for specified operations or tasks, e.g., as specified by an admin user via a DAP platform or other platform. In some exemplary embodiments, by designing the launchers of the copilot to utilize LLM technology in a controlled responsible manner, the copilot may ensure the reliability of outputs generated based on LLMs.

In some exemplary embodiments, in order to further preserve the users' privacy, and prevent leakage of their Personal Identifiable Information (PII) data to the LLM (e.g., for an LLM that is not on premise), data from the user may be anonymized before the data is provided to an LLM engine (e.g., via the chat widget). For example, a launcher may be configured to remove PII data from the data that it provides to the LLM, replace PII data with non-PII data, alter the PII data to non-PII data, or the like, before providing the data to the LLM. In some exemplary embodiments, by removing PII data, the privacy of users may be maintained. In some cases, PII data may be identified and replaced using heuristic-based rules, private language models, on premise language models, or the like.

In some exemplary embodiments, an output of an automation process may be defined based on one or more LLM sessions, one or more non-LLM operations, or the like. In some cases, an output may be generated (e.g., by the assistance layer) to incorporate a portion of a response from an LLM session, an indication of the response from the LLM, the entire response from the LLM, or the like. For example, the output may combine a result obtained from an LLM session with a statically defined guidance.

In some exemplary embodiments, generated output of an automation process (e.g., from the LLM engine) may be configured to be presented according to one or more presentation configurations. In some exemplary embodiments, the generated output may be presented within the chat widget of the copilot, as a message. In other cases, the output may be presented in any other way, e.g., as an overlay over the GUI, such as a popup element, a tooltip, a window, a balloon, a textbox, a chat widget, or the like, or by adjusting the layout of the GUI.

It is noted that although the disclosed subject matter is exemplified with respect to a launcher of a copilot, the disclosed subject matter may be utilized for any other DAP building block of any other software assistant. It is further noted that the disclosed subject matter is not limited to a specific digital adoption platform, and can be implemented for non-DAP platforms as well. Additionally, although the disclosed subject matter is exemplified with respect to textual prompts to LLM engines, the disclosed subject matter is limited to such scenarios, and any other types of data may be communicated with the LLM engine, e.g., images, screenshots, or the like.

One technical effect of utilizing the disclosed subject matter is aiding human users in completing digital tasks, by combining the contextuality of launchers with the engine of the copilot. For example, using the disclosed subject matter, end users may benefit from both technologies, and may be assisted with digital tasks in real time, in an interactive manner, efficiently, or the like, which may enhance the productivity and engagement of end users. In some exemplary embodiments, the disclosed subject matter may be configured to provide users with a “push experience” in which assistance (in the form of launchers in the copilot bar) is actively delivered or pushed to the user without explicit action on the user's part. The provided “push experience” may enhance the user experience by reducing his cognitive load, minimizing the number of user actions required to obtain services, increasing interactivity, and providing better contextual support.

Another technical effect of utilizing the disclosed subject matter is providing a framework for assisting end users, that can re-use existing launchers. For example, launchers designed according to U.S. patent application Ser. No. 18/661,229, entitled “Defining Widgets And Executing Them Over An Application”, filed May 10, 2024, may be reused by merely assigning them to a copilot.

Yet another technical effect of utilizing the disclosed subject matter is providing a framework for assisting end users, that does not require admin users to select a location for presenting each launcher. For example, launchers designed according to U.S. patent application Ser. No. 18/661,229, entitled “Defining Widgets And Executing Them Over An Application”, filed May 10, 2024, may be required to be defined with a location that is adjacent to a selected page element, even if the launcher is not associated to any page element in particular (e.g., page-level launchers). In contrast, the disclosed subject matter enables to present all launchers within the bar widget of the copilot, without requiring admin users to select a location for presenting each launcher.

Yet another technical effect of utilizing the disclosed subject matter is providing an improvement in DAP platforms, offering combined copilot and launcher capabilities.

Yet another technical effect of utilizing the disclosed subject matter is providing a user-friendly solution that may increase a user engagement. In some cases, a human to machine interaction may be enhanced by providing an interactive copilot that is context aware, and by enabling users to obtain a result of a context-based automation process by a mere selection of a launcher, without requiring additional user input.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

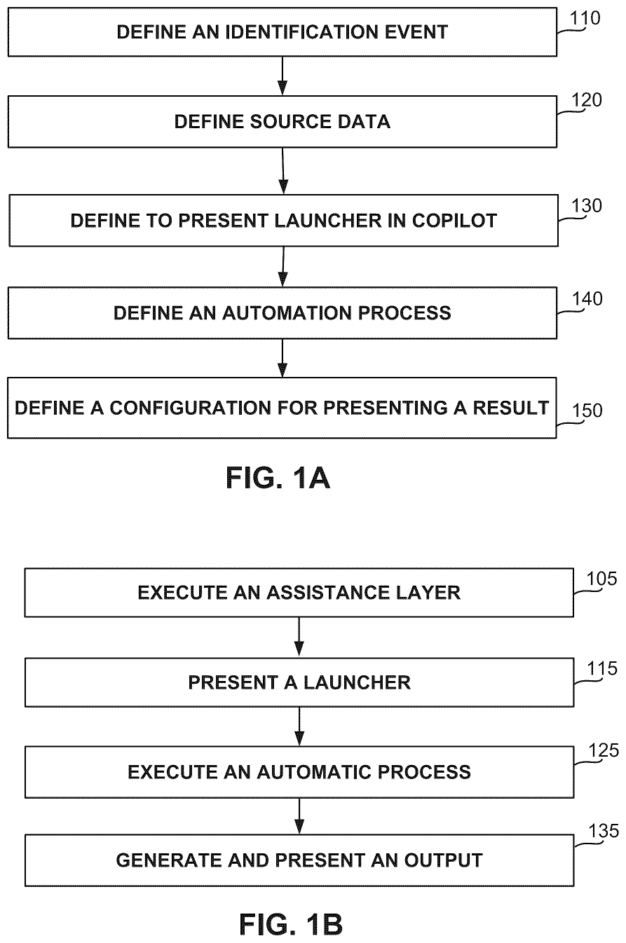

Referring now to FIG. 1A showing a flowchart diagram of a method for configuring a software assistant, in accordance with some exemplary embodiments of the disclosed subject matter.

On Step 110, one or more identification events associated with one or more GUIs of a third-party application may be defined. For example, an identification event may be defined by an admin user using an editor of a DAP platform. In other cases, the identification event may be defined in any other manner, platform, or the like.

In some exemplary embodiments, the third-party application may be executable on a plurality of end devices of end users, and on an end device of the admin user. In some exemplary embodiments, the DAP platform, through which the identification event is defined, may be agnostic to third-party applications, and may not have access to their backends, may not perform API calls thereto, or the like. For example, the third-party application may be independent from the DAP, may not have API communications therewith, may not have backend communications therewith, or the like.

In some exemplary embodiments, using the DAP platform, the admin user may generate an assistance layer that can be executed over the third-party application by the plurality of end devices. In some exemplary embodiments, an assistance layer may be defined and generated, and used to assist end users with performing one or more functionalities in one or more third-party applications. In some exemplary embodiments, the assistance layer may comprise a software assistant, such as a software copilot, that presents one or more DAP building blocks such as launchers, to end users.

In some exemplary embodiments, the software assistant may comprise a widget, a bar, an overlay, or the like, such as a copilot bar, that can be presented over a GUI of the third-party application. In some exemplary embodiments, the software assistant may be defined, configured, or the like, via the DAP.

In some exemplary embodiments, the identification event may be configured to, when detected, cause one or more widgets such as launchers to be presented within the software assistant. For example, the launchers may comprise one or more GUI controls such as buttons, selectable items, or the like, presented within a software copilot rendered over a GUI of the third-party application. In some exemplary embodiments, launchers may be presented as an overlay over the third-party application, within the overlay of the software assistance. In some exemplary embodiments, the launcher may not be defined by the third-party application. For example, the launcher may be defined by an admin user via the DAP, to be applied over a third-party application that is not associated with the DAP.

In some exemplary embodiments, a launcher presented within the software assistant may indicate one or more automation processes that are defined for the identification event. For example, the identification event may indicate that a defined automation process is found to be associated with the GUI of the third-party application. In some exemplary embodiments, the launcher may indicate an automation process that can be performed, an automation process that was performed, or the like. In some cases, an automation process may be indicated by a text string presented by a launcher and describing the automation process, a linked text string presented by a launcher, a GUI control, a drawing presented by a launcher, or any other visual element, audio indication, or the like, presented by the launcher and indicating the respective automation process. For example, the text string may describe the automation process, a name of the automation process, a goal of the process, any other property associated with the automation process, or the like. In other cases, a launcher may indicate an automation process in any other way.

In some exemplary embodiments, the visibility of the software assistant may or may not depend on occurrences of identification events. In some exemplary embodiments, the software assistant (e.g., the copilot) may be configured to become visible for a defined timeframe, after every occurrence of an identification event. In some exemplary embodiments, after the defined timeframe elapsed, the software assistant may revert to being invisible, may become invisible again, or the like. In other cases, the software assistance may be configured to remain visible throughout its execution over the third-party application on the end devices, regardless of occurrences of identification events.

In some exemplary embodiments, an admin user may set one or more conditions that define identification events. In some exemplary embodiments, the identification event may be identified according to one or more conditions associated with a page context of the GUI (e.g., text presented in the GUI or any other property of the GUI). In some exemplary embodiments, the conditions may relate to a context of the GUI such as an element in the GUI, an address of a page rendering the GUI of the third-party application, a user segment of end users, a user interaction with the GUI, one or more properties of the GUI, text in the GUI, a type of form represented by the GUI, a combination thereof, or the like. For example, the identification event may be defined to occur when text is selected by the user, when user input is provided to a GUI element, when text in a displayed GUI complying with a condition, when a specified element becomes visible or invisible in the GUI, when a specified URL of a page is loaded in the GUI, when a predefined element is detected in the screen, when a user hovers over a defined element, when a predefined type of session is identified in the screen, when a predefined type of form is rendered in the GUI, a combination thereof, or the like.

For example, the conditions may relate to properties of the GUI such as a first property of a first GUI element in the GUI, and a second property of a second GUI element in the GUI. According to this example, the conditions may define a logical relationship between the first and second properties, e.g., defining that the identification event occurs in case both elements are visible, in case one element is visible and the other is not, or the like. As another example, the conditions may relate to address of a page rendering the GUI, such as a URL of the page. According to this example, upon determining that the URL matches a predefined list of one or more URLs, the identification event may be identified.

As another example, the identification event may be identified by automatically determining that one or more initial conditions are complied with, performing an automation process based thereon, and determining based on the automation process that one or more subsequent conditions are complied with. In some cases, this process may be performed iteratively for any number of automation processes, conditions, or the like. For example, the initial conditions may comprise identifying that text is selected, that the GUI resembles a submitted support ticket, that an identification event occurs, that is predefined element is visible or included in the GUI, or the like. According to this example, compliance with the initial conditions may cause an automation process to be executed, e.g., a prompt to an LLM engine to be generated automatically, such as a prompt incorporating at least some text from the GUI and asking the LLM engine whether the text indicates that a customer is frustrated. In case that the output of the LLM engine indicates that the customer is indeed frustrated, one or more subsequent conditions may be determined to be complied with, causing at least one launcher to be presented within the software assistance. For example, the launcher may indicate one or more automation processes that are only relevant for frustrated customers. In other cases, the LLM engine may be instructed with any other tasks, such as sematic analysis tasks, text generation tasks, or the like.

In some exemplary embodiments, identification events may be polled periodically, continuously, or the like, to determine whether launchers are still relevant. For example, launchers that become irrelevant may be rendered invisible. For example, the GUI may be polled to determine whether the conditions of the identification event are still complied with, and upon identifying that they are not complied with any more, the launcher may be rendered invisible. This way, launchers may be removed from the software assistant based on a context of the GUI, and adjusted according to context changes. For example, if a launcher is removed and subsequently its conditions are complied with, the launcher may appear again in the software assistance.

In some exemplary embodiments, since the software assistant may not have access to the backend of the third-party application, and there may be no API available, the software assistant may be configured to identify the identification event by monitoring and analyzing the GUI of the third-party application. In some cases, an occurrence of an identification event may be identified using one or more acquisition techniques, such as those disclosed in U.S. Pat. No. 10,620,975, entitled “GUI Element Acquisition Using A Plurality Of Alternative Representations Of The GUI Element”, dated Apr. 14, 2020, which is incorporated by reference in its entirety for all purposes without giving rise to disavowment. For example, such acquisition techniques may enable to identify whether conditions of an identification event are complied with in a GUI.

On Step 120, source data associated with a presented launcher may be defined, e.g., by an admin user using a DAP platform. In some exemplary embodiments, the source data may be defined, configured, or the like, via a digital adoption platform, or DAP. In some exemplary embodiments, the source data may be defined to comprise at least a portion of the text in the GUI of the third-party application.

In some exemplary embodiments, the launcher may be defined in association with source data that is to be processed by the automation process of the launcher. For example, in response to identifying the identification event, the defined source data may be extracted from the GUI. In some exemplary embodiments, the source data may be configured to be processed, at least in part, by an automation process of a launcher.

In some exemplary embodiments, the source data may comprise at least a portion of the text in the GUI. For example, the source data may comprise text associated to an element that is displayed in the GUI (e.g., the GUI element for which the identification event is defined). As another example, the source data may comprise selected text that is rendered in the GUI, e.g., selected by an end user. As another example, the source data may comprise all text that is displayed in the GUI, all text that is rendered in the page or GUI, text associated with a support ticket, or the like. As another example, the source data may comprise text from an HTML element, such as text from the <body> element. In some exemplary embodiments, the source data may comprise text extracted from a GUI of a page of a third-party application, a third-party mobile application, a third-party desktop application, or the like.

In some cases, more than one automation process may be defined for the same source data. For example, two or more launchers may be presented in the assistance layer in response to the same identification event, the launchers comprising automation processes that process the same source data. For example, first and second automation processes may be defined for a same source data, resulting with first and second launchers being presented within the software assistant. In other cases, a single automation process may be defined for the source data.

On Step 130, at least one launcher associated with the automation process may be defined to be presented in the software assistant over the GUI of the third-party application, in response to identifying an occurrence of the identification event. In some exemplary embodiments, the automation process of the launcher may be defined, configured, or the like, by an admin user using a DAP platform. In some exemplary embodiments, a launcher may be defined to be presented in case the identification event is identified, and in association with source data of the GUI.

In some exemplary embodiments, the admin user may use the DAP platform to configure the launcher, its properties, its presentation, its depicted text, color, or the like. In some exemplary embodiments, the properties and configurations of launcher may be pre-defined by the admin user, defining the type of widget of the launcher, a presentation of the launcher, its trigger event, or the like. In some exemplary embodiments, the launcher may comprise an overlay that is configured to be rendered on top of the GUI of the third-party application, e.g., within a widget of the software assistance.

In some exemplary embodiments, the admin user may associate the launcher with an automation process, and define a trigger event configured to cause the automation process to be executed. For example, the trigger event associated with the launcher may comprise a user interaction with the launcher.

In some exemplary embodiments, although the launcher may in some cases be associated to a specific GUI element, this may not affect the manner of presenting the respective launcher. For example, the launcher may be presented within the software assistant, and not adjacently to the element. For example, the launcher may be presented within the software assistant regardless of the area in the GUI to which the automation process and source data relates. In other cases, the launcher may be presented in any other location in the GUI.

On Step 140, an automation process associated with a presented launcher may be defined, by an admin user using a DAP platform. In some exemplary embodiments, the automation process may be configured to be invoked in response to one or more trigger events, conditions, or the like, such as a user selecting the launcher defined on Step 130 that is presented in response to the identification event defined on Step 110. For example, the automation process may be executed in response to a user selection of the launcher, a user hovering over the launcher, a vocal command associated with the launcher, or the like.

In some exemplary embodiments, the trigger event may be defined, by an admin user using a DAP platform, to trigger, cause or invoke an activation of an automation process of the launcher. For example, the trigger event may comprise a user interaction of an end user, such as a selection of the launcher. As another example, the trigger event may comprise determining that a condition associated with text presented in a GUI is complied with. In other cases, the trigger event may comprise any other event, condition, branch of conditions, or the like. In some exemplary embodiments, the trigger event may comprise an interaction of an end user with the launcher, e.g., after the launcher is presented.

In some exemplary embodiments, the software assistant may be configured to, in response to an occurrence of a trigger event associated with the launcher, execute the automation process of the launcher. In some exemplary embodiments, the admin user may set or configure each launcher to invoke one or more respective automation processes, in response to a trigger event. In some exemplary embodiments, the automation process may be configured to process the source data that is defined in Step 120 and to output a result. In some exemplary embodiments, each automation process may comprise one or more rules, conditions, or the like, which may be configured to process respective source data when executed.

In some exemplary embodiments, an automation process of a launcher may or may not incorporate one or more LLM engines. In some cases, the automation process may exploit LLM technology, such as to perform one or more text analysis tasks, text generation tasks, tasks that require NLP processing, a combination thereof, or the like. In some exemplary embodiments, an automation process may encompass one or more LLM operations, in which an LLM is utilized with a defined prompt. In some exemplary embodiments, a text analysis task may refer to any task that is designed to assist end users with analyzing, reviewing and/or understanding text.

In some exemplary embodiments, in case an LLM engine is utilized, the automation process may comprise generating a prompt for the LLM engine, the prompt comprising a predefined structure of a dynamic portion and a static portion. In some exemplary embodiments, the dynamic portion may be configured to be populated with the source data every invocation of a trigger event. For example, the dynamic portion may be replaced with first source data after a first trigger event, and with second source data after a second trigger event. In addition to incorporating the source data, the dynamic portion may be populated with input from the end user, such as data entered into a field of the GUI. As an example, a first dynamic portion of a prompt may be replaced with a user input, and a second dynamic portion of the prompt may be replaced with the source data.

In some exemplary embodiments, the static portion may comprise one or more client-specific requirements scripted by the admin user, one or more cross-client instructions or commands that remain consistent across different clients and respective admin users, or the like. For example, the static portion of the prompt may be set to comprise a background section describing a background of the automation process, a command section comprising a request for processing the dynamic portion according to the automation process, a user segment section for personalizing the automation process according to a user segment of each end user, or any other instruction related to the automation process. In some exemplary embodiments, the prompt may be provided to the LLM engine, processed thereby, and an output from the LLM engine may be obtained based on the prompt.

For example, in case the page includes one or more fields reflecting a submission of another user, the prompt may be generated to instruct the LLM engine to perform a text generation task configured to assist an end user with responding to the submission. As another example, in case the page includes one or more fields reflecting a submission of another user, the prompt may be generated to instruct the LLM engine to perform a text analysis task analyzing text of the submission, in order to provide an end user with insights useful to handle the submission. For example, a text analysis task may comprise a reading comprehension task intended to assist end users with understanding the meaning or main idea of passages, documents, submitted forms, or the like, and answering questions based on the content.

In some exemplary embodiments, generating the prompt may or may not include removing PII data from the source data in the prompt, replacing PII data in the source data of the prompt with non-PII data, or the like. For example, this may be performed using a predictor trained to identify PII data, using heuristic rules for identifying and replacing PII data (e.g., according to format of phone numbers and email addresses), or the like.

In some cases, the automation process may not exploit LLM technology, and may instead perform one or more operations using regular expressions, syntactical constraints, heuristics, acquisition processes of GUI elements, or the like. For example, the automation process may execute a walkthrough over the GUI without utilizing LLM technology. For example, the walkthrough may be executed according to one or more methods disclosed in U.S. Pat. No. 9,922,008, entitled “Calling-Scripts Based Tutorials”, dated Mar. 20, 2018, using one or more acquisition techniques disclosed in U.S. Pat. No. 10,620,975, entitled “GUI Element Acquisition Using A Plurality Of Alternative Representations Of The GUI Element”, dated Apr. 14, 2020.

In some cases, the automation process may be configured to be performed with respect to a knowledge base, a data repository, a content source, a content source external to the copilot engine, or the like (referred to as the “content source”). For example, in case LLM technology is utilized by the automation process, the prompt to the LLM may be generated based on at least a portion of retrieved data that is retrieved from the content source, e.g., by executing a query thereover. In some cases, the prompt may instruct the LLM engine to perform one or more actions with respect to a content source, e.g., a database, file, repository, or the like. For example, the LLM engine may be instructed to retrieve one or more requirements from the content source, and incorporate the retrieved requirements in the prompt, thereby adjusting the prompt. As another example, the automation process may execute a search engine that has access to the content source, and the prompt may be generated to incorporate retrieved text from the search engine. As another example, the content source may be utilized by executing non-LLM operations thereon. In some exemplary embodiments, retrieved data from the content source may be selected to be retrieved in case it conforms to one or more conditions, rules, or the like. For example, in case the data conforms with a similarity metric with respect to the source data, with respect to portion of the predefined structure of the text portion, or the like, the data may be extracted as an answer.

On Step 150, a configuration for presenting a result of the automation process in the GUI may be defined, e.g., by the admin user using the DAP. In some exemplary embodiments, the result may be determined based on an output from the LLM engine, an output from a non-LLM operation, or an output from any other automation process. For example, a result of an automation may be determined based on one or more LLM sessions, one or more syntactical rules, a combination thereof, or the like. In some cases, the presentation of the result may be performed as part of the automation process, or independently therefrom.

In some exemplary embodiments, the admin user may set or configure a manner of presenting a result of an automation process. For example, a result presentation configuration may define that the result should be presented as a message in the chat widget of the copilot.

In other cases, the result may be set to be presented in any other position over the GUI, within any other element, or the like.

In some exemplary embodiments, the configuration of presenting the result may comprise updating one or more properties of the GUI based on the result from the automation process. For example, one or more properties of the GUI such as a color of a text element, a highlighting of a text element, a color of a non-text element, or the like, may be updated. As another example, the result may be inserted in a textbox in the GUI and displayed thereby. As another example, the result may be presented in a textbox by updating a visual characteristic of at least a portion of the textbox, appending the result thereto, replacing text in an existing textbox with the result, or the like. As another example, the result may be presented in a text input field, e.g., by appending the result to pre-existing text in the text input field. As another example, the result may be presented in a text input field by updating the text input field to incorporate and display the result, e.g., instead of the previous text of the element. As another example, the result may be presented in a popup element that is configured to be displayed over the GUI, the popup element not being part of the underlying third-party application. As another example, the result may be presented in a chat widget that is not part of the third-party application. For example, the chat widget may enable the end user to ask natural language questions regarding the third-party application. As another example, the result may be presented as an alert, notification, or the like. As another example, the result may be presented within an existing text field. As another example, the result may be presented as an overlay that is configured to dynamically match the layout of the underlying GUI, e.g., in color, shape, size, or the like. As another example, the result may be indicated as an image or element, such as a green marking for proper input and a red marking (e.g., alone or in addition to a text element with suggestions) for improper input.

It is noted that although the source data may be associated to a specific GUI element, this may not affect the manner of presenting the result of the automation process. For example, the launcher may be presented within the software assistant, and not adjacently to the element.

In some exemplary embodiments, Steps 110-150 may be performed for any number of identification events, launchers and automation processes. For example, the admin user may define via the DAP first and second different identification events configured to cause first and second launchers to be displayed within the software assistant, respectively, each associated with a different automation process. According to this example, the software assistant may be configured present the first launcher in response to the first identification event and to present the second launcher in response to the second identification event. The first and second source data may be defined for the launchers, respectively, and may be processed by respective, different, automation processes, in response to respective trigger events. For example, an automation process of a first launcher may utilize an LLM engine, while an automation process of the second launcher may execute a walkthrough without using an LLM engine. In some cases, each generation of a launcher may be performed according to Steps 110-150.

In some exemplary embodiments, Steps 110-150 may be performed via the digital adoption platform, or via any other platform, as part of generating an assistance layer. In some exemplary embodiments, after the assistance layer is generated, the assistance layer may be distributed to end devices, embedded in the pages of the digital task, executed on end devices, or made accessible to the end devices in any other way. In some exemplary embodiments, end devices may execute the third-party application, and simultaneously execute the assistance layer, thereby executing the software assistance over the third-party application. For example, the software assistance may be executed over an end device of an end user according to the steps of FIG. 1B. In some exemplary embodiments, the defined launchers may be activated by the software assistance, presented by the software assistance, or the like, e.g., in response to identification events.

In some exemplary embodiments, in some cases, instead of configuring the launcher from scratch, one or more existing launchers may be re-used by assigning them to the copilot. For example, a launcher may be defined and deployed by a proprietary third-party website, and, instead of performing Steps 110-150, the admin user may re-use the launcher by the assistance layer. As another example, one or more configurations of a launcher may be set by other admin users, by other entities, or the like, and re-used by the admin user. In other cases, separate launchers may be used for a same digital assistance, once defined by a proprietary application and once by an admin user via the DAP.

In some exemplary embodiments, in some cases, instead of using a DAP editor to configure a launcher, an admin user may configure a launcher using a console or Command Line Interface (CLI) directly. For example, a console may enable admin users to define launchers for a third-party application. In some cases, a tree may be defined for the third-party application, in which the leaves are individual launchers. The admin user may define for each launcher the respective source data, such as text from an element in the page, marked text, all page text, or a source external to the page. Additionally, or alternatively, the console may be utilized to define one or more LLM rules for each launcher, such as but not limited to identification rules. In some cases, trees of launchers may be defined for each third-party application, via the console. The console may enable easy definition of a menu system, supporting various automation processes for every third-party application.

For example, the admin user may define, using the console, in natural language an identification event such as “if the page has a LinkedIn™ profile”, causing an automation process to be executed or indicated via a displayed launcher. For example, the automation process may be configured to use the HTML <body> element as its source data, and may be prompted to determine whether the identification event is identified in the <body> element. In some cases, the admin user may define an instruction to the launcher to indicate an action (e.g., an automation process) to be performed when the identification rule is met. For example, the user may define a rule configured to cause the automation process to summarize the identified profile (e.g., using the LLM prompt “summarize the resume appearing in the text”), in response to the identification event. For example, a single prompt may be generated to instruct an LLM engine to first apply an LLM rule on the source data (“if the page has a LinkedIn™ profile”), and if true, to perform a second operation (“summarize the resumes appearing in the text”). In other cases, a launcher for summarizing the profiles may appear in response to identifying the identification event, causing the automation process to be executed in response to a user selection. A copilot with such configurations may be injected into LinkedIn™ pages of end users and executed thereon.

Referring now to FIG. 1B showing a flowchart diagram of a method, in accordance with some exemplary embodiments of the disclosed subject matter.

On Step 105, a third-party application may be executed on an end device of an end user. For example, the third-party application may be launched over a user device, enabling the rendering one or more pages that the end user can engage with interactively. In some exemplary embodiments, simultaneously, an assistance layer may be executed over the third-party application. For example, the assistance layer may comprise a SaaS application, a desktop application, an extension to a browser, a Software Development Kit (SDK), a shared library, a Dynamic Link Library (DLL), or the like.

In some exemplary embodiments, the assistance layer may comprise a software assistance, such as a copilot, which may be executed over the third-party application and presented as an overlay thereon. In some exemplary embodiments, the assistance layer may be configured to assist end users with performing a digital task associated with a GUI of a third-party application.

On Step 115, in case one or more identification event are identified within the GUI of the third-party application, e.g., by the assistance layer, one or more respective launchers may be presented or made visible within the software assistant, over the GUI of the third-party application. In some exemplary embodiments, the launchers may not be defined or programmed by the third-party application, but rather may be generated by an admin user via a DAP that is not associated with the third-party application.

In some exemplary embodiments, a launcher may be presented in the software assistance in response to an identification event, e.g., the identification event defined in Step 110 of FIG. 1A. For example, the launcher may be presented in the software assistant in response to identifying that a GUI element is visible in the GUI, that a specified URL is rendered, a negative sentiment in a support ticket that is submitted for review, that the GUI represents a specified form type, or the like.

In some exemplary embodiments, a launcher may present an indication of the automation process, with which it is associated. For example, the admin user may define the launcher to comprise the automation process, and to execute the automation process in response to a trigger event. In some exemplary embodiments, the trigger event may be defined to comprise an interaction of the end user with the launcher, such as a selection of the launcher, hovering over the launcher, or invoking the launcher in any other way. In some exemplary embodiments, the trigger event may be defined according to Step 130 of FIG. 1A, e.g., by an admin user.

In Step 125, in response to an invocation of the trigger event, the automation process may be executed, activated, invoked, or the like. For example, the automation process may be executed in response to the user selecting the launcher.

In some exemplary embodiments, executing the automation process may comprise performing one or more predefined operations, as defined by the admin user via the DAP. In some cases, at least some of the operations may be defined on source data extracted from the GUI. In some exemplary embodiments, source data for the automation process may be automatically extracted and obtained from the GUI, e.g., according to source data defined on Step 120 of FIG. 1A. In some exemplary embodiments, the source data may be identified in response to the user interaction, before the user interaction, or the like. In some exemplary embodiments, executing the automation process may comprise processing the source data.

In some exemplary embodiments, the predefined operations may process the source data using one or more LLM-based operations, non-LLM operations, or the like. For example, the operations may comprise generating a prompt to a LLM engine, e.g., on the source data.

On Step 135, an output may be generated and presented to the end user, based on the automation process. In some exemplary embodiments, the automation process may comprise generating an output based on one or more sub-operations. For example, the automation process may comprise obtaining an output from an LLM engine, obtaining a second output from a non-LLM engine, and combining them according to one or more heuristic rules. For example, one or more rules may be defined and used for performing a post-processing stage of a plurality of outputs of sub-operations of the automation process, and the output of the post-processing stage may be presented to the user.

In some exemplary embodiments, the output may comprise data that corresponds to a semantic analysis of the source data, data that corresponds to a summarization of text, data that corresponds to a verification of user input, data that corresponds to any other text analysis task, data that corresponds to any other text generation task, or the like. In some cases, the output may incorporate one or more outputs of the automation process (e.g., from an LLM engine), a portion thereof, or the like.

In some exemplary embodiments, the output may be presented to the end user, e.g., based on a configuration for presenting the result as defined on Step 160 of FIG. 1A. In some exemplary embodiments, the result may be presented over the GUI of the third-party application according to the defined configuration, according to a target location for the presentation, or the like. For example, the result may be concatenating into existing fields in the GUI, may replace text in existing fields in the GUI, may be presented within a widget overlaid over the GUI and not defined by the GUI, or the like. In some exemplary embodiments, the output may be configured to assist end users with performing digital tasks, such as reviewing support tickets.

Referring now to FIGS. 2A-2E depicting exemplary user interactions with a deployed software assistance, in accordance with some exemplary embodiments of the disclosed subject matter.

In some exemplary embodiments, launchers of the software assistant may assist end users with performing a plurality of content-related digital tasks, text-based digital tasks, or the like, e.g., as depicted in FIGS. 2A-2E. In some exemplary embodiments, text-based digital tasks may comprise any task or operation that involves or is based on text provided by an end user or reviewed by an end user. In some exemplary embodiments, text-based digital tasks may comprise filling out forms, submitting forms, reviewing form submissions, responding to form submissions, or the like. For example, LLM technology (or any other language model) may be utilized to revise the user's inputted text, refine text written by the end user, provide suggestions for text revisions, or the like. As another example, LLM technology may be utilized to enhance a process of reviewing form submissions, such as by providing summaries of the submitted text, insights regarding the semantic properties of the submitted text, insights from text that is to be reviewed by the end user, or the like.

As depicted in FIG. 2A, an end device of an end user may execute a third-party application, such by rendering Gmail™ on a web browser, and, simultaneously, the end device may execute an assistance layer over the Gmail™ page. In some exemplary embodiments, the presence of the assistance layer may be indicated, e.g., by Widget 220 representing a software assistant of the assistance layer, by a displayed software assistance, or the like.

In some exemplary embodiments, a software assistant such as a copilot may be incorporated within the assistance layer, and may be executed over the third-party application, e.g., Gmail™. For example, the software assistant may be defined by an admin user using a DAP platform, a DAP editor, or the like. In some cases, the DAP editor may be adjusted to enable users to embed pre-defined or new launchers within a copilot (in addition to or instead of defining launchers independently from the copilot).

In some exemplary embodiments, Widget 220 representing the software assistant in a hidden visibility mode. For example, Widget 220 may comprise a trigger widget, tooltip, launcher, or the like, that, when activated by the end user, causes the software assistant to be displayed in a full visibility mode. In other cases, the copilot may displayed by default, and may enter the hidden visibility mode based on a user interaction. In some exemplary embodiments, in case the end user selects or activates Widget 220, the copilot may be displayed, e.g., as depicted in FIG. 2B.

For example, the copilot may be displayed in a full visibility mode, such as by presenting a chat widget such as Chat Widget 230 that enables the end user to engage in natural language conversations with the AI-powered engine of the copilot. In some exemplary embodiments, Chat Widget 230 may comprise a Text Field 232, through which the end users may enter natural language questions or commands to the copilot. For example, the copilot may be configured to address commands and questions of end users regarding the end device over which the copilot is executed, applications executed on the end device, activation of web-based search engines, settings of the end device, the context of text in a rendered application page, or the like. In some cases, the engine of the copilot may not necessarily be defined via the DAP, but may rather incorporate a third-party engine of copilots.

In some exemplary embodiments, the disclosed subject matter enables to provide, through the copilot, additional services in addition to the chat widget. For example, in addition to Chat Widget 230, the software assistant may be configured to present a Copilot Bar 240, as depicted in FIG. 2C.

In some exemplary embodiments, in contrast to Chat Widget 230, which is activated or launched based on explicit user instructions or by default, Copilot Bar 240 may be presented automatically based on a context of rendered page in a display of the end device. In some exemplary embodiments, Copilot Bar 240 may be configured to present one or more context-based launchers to end users, based on a context of the rendered pages of the third-party application.

In some exemplary embodiments, the software assistant may be configured to present context-based launchers within a widget such as Copilot Bar 240. In the scenario of FIG. 2C, since the context of the rendered page is an email being written by the end user, Copilot Bar 240 may present relevant launchers such as Summarize 242, Rephrase 244, and Translate 246.

In some exemplary embodiments, each launcher presented in Copilot Bar 240 may be defined (via the DAP) with an associated identification event, defining when the launchers should appear in Copilot Bar 240. For example, the launchers of Summarize 242, Rephrase 244, and Translate 246 of FIG. 2C may be displayed in response to the end user select Text Portion 238. According to this example, the identification event defined for the launchers may comprise identifying that the end user selected text in the rendered page of the third-party application.

In some exemplary embodiments, in order to determine which launchers to present, if any, the GUI of the end device may be polled to identify compliance with one or more conditions, identification events, or the like, which may be defined by the admin user via the DAP. For example, the identification events may be defined to comprise identifying a defined URL or page address, to identify a selection of text within an email domain such as Gmail™ to identify a format that visually resembles a writing digital task, or the like. In some cases, the different launchers may be defined with different or same identification events. Based on processing the display of the third-party application, the software assistant may determine whether one or more identification events have occurred, causing respective launchers to be presented in Copilot Bar 240.

In some exemplary embodiments, in contrast to launchers that are not defined within a copilot, resulting with such launchers being presented adjacently to respective page elements, the launchers defined for the software assistant may be presented in Copilot Bar 240 regardless of the locations of page elements that are associated to the launchers, e.g., even if the page elements are not adjacent to Copilot Bar 240.

In some exemplary embodiments, in the scenario of FIG. 2C, Copilot Bar 240 displays launchers such as Summarize 242, Rephrase 244, and Translate 246. In some exemplary embodiments, Summarize 242 may be configured to execute an automation process that summarizes text from the GUI, Rephrase 244 may be configured to execute an automation process that is configured to rephrase text from the GUI according to one or more target tones or attributes (e.g., more professional, more casual, or the like), and Translate 246 may be configured to execute an automation process that is configured to translate text from the GUI into a defined language.

In some exemplary embodiments, each automation process of a launcher may be defined (via the DAP) to be activated or invoked in response to a trigger event. For example, a trigger event of each of Summarize 242, Rephrase 244, and Translate 246 may be a user selection of the respective launcher, a use interaction with the launcher, or the like. In other cases, any other trigger event may be defined for any of the launchers.

In some exemplary embodiments, source data of each launcher may define which text or content of the page should be processed by the automation process. The source data may or may not correspond to text that caused an identification event to be identified. For example, source data of each of Summarize 242, Rephrase 244, and Translate 246 may be comprise selected text in the page that is selected by the user, text associated with a specific page element (e.g., a field), input from the end user, or the like. For example, in case Translate 246 is configured to process source data that comprises selected text, Translate 246 may translate any text that is selected by the end user, without translating the remaining text in the page.

In some cases, an automation process of a launcher may or may not utilize one or more technologies such as LLM engines (e.g., GTPs), NLP models, supervised ML models, unsupervised ML models, or the like. For example, in case an automation process requires text analysis tasks, text generation tasks, or the like, an LLM engine may be used for implementing at least part of the automation process.

In case an LLM engine is utilized, the automation process of the respective launcher may generate a prompt to the LLM engine, send the prompt to the LLM engine, and obtain an output from the LLM engine in response to the prompt. For example, a prompt of the automation process of Summarize 242 may instruct the LLM engine to summarize text of the source data that is extracted from the page. As another example, a prompt of the automation process of Rephrase 244 may instruct the LLM engine to rephrase text of the source data that is extracted from the page to be more formal, to be written as an email, or the like. As another example, a prompt of the automation process of Translate 246 may instruct the LLM engine to translate text of the source data that is extracted from the page into one or more defined languages.

In some exemplary embodiments, after executing an automation process of a launcher, a result may be generated for the end user. In some cases, the result may be generated by the automation process, by the software assistant independently from the automation process, or the like. For example, in case of an LLM-based automation process, the result may be generated based on an output from the LLM engine (e.g., by combining at least a portion of the output with scripted text, a defined format, order, or the like).

In some exemplary embodiments, the result may be presented according to one or more defined configurations. For example, the result may be presented as an overlay within a balloon widget, tooltip, a popup window, or the like, on top of the GUI. As another example, the result may be incorporated within the GUI, e.g., within an existing GUI element, by highlighting portions of the existing text in the page that correspond to the summary, or the like.

In some cases, the result may be presented within a chat widget, e.g., as depicted in FIG. 2D. For example, the result may be presented as a message (Message 252) from Chat Widget 230, and/or the launcher selected by the end user prior to the automation process may be presented as a message from the end user within Chat Widget 230. In some exemplary embodiments, Copilot Bar 240 may be presented together with Chat Widget 230, or separately therefrom. In some exemplary embodiments, the end user may be enabled to customize one or more settings or properties of Copilot Bar 240. For example, the end user may position Copilot Bar 240 at a desired position. In some cases, Copilot Bar 240 may manifest as a side bar, a top bar, a bottom bar, or similar variant, and users may have the option to reposition it within the page. For example, users may be enabled to drag Copilot Bar 240 to their preferred page side. In other cases, Copilot Bar 240 may be positioned in one or more constant locations, e.g., at the bottom of the screen, which may be independent from positions of elements in the third-party page.

In some cases, the end user may be enabled to customize other aspects of Copilot Bar 240. For example, the end user may add a customized launcher for his own use, e.g., as depicted in FIG. 2D. According to this example, the end user may be enabled to add, via a control of Copilot Bar 240, a new launcher for text analysis tasks, text generation tasks, or the like. In the scenario of FIG. 2D, the end user may define a text generation task via GUI 260, using free text in natural language. The end user may name the respective launcher “write as email”, and write the prompt to state: “write the text as email”, thereby generating a launcher that can obtain text and adjust the text to match a style of an email message. In this example, the remaining settings of the launcher (e.g., the identification and trigger events) may correspond to default settings. In other cases, GUI 260 may enable end users to define any other aspects of the personalized launcher. In some cases, the user may be enabled to customize any other aspects of Copilot Bar 240 such as the size of Copilot Bar 240, its color scheme (dark or light mode), or the like.

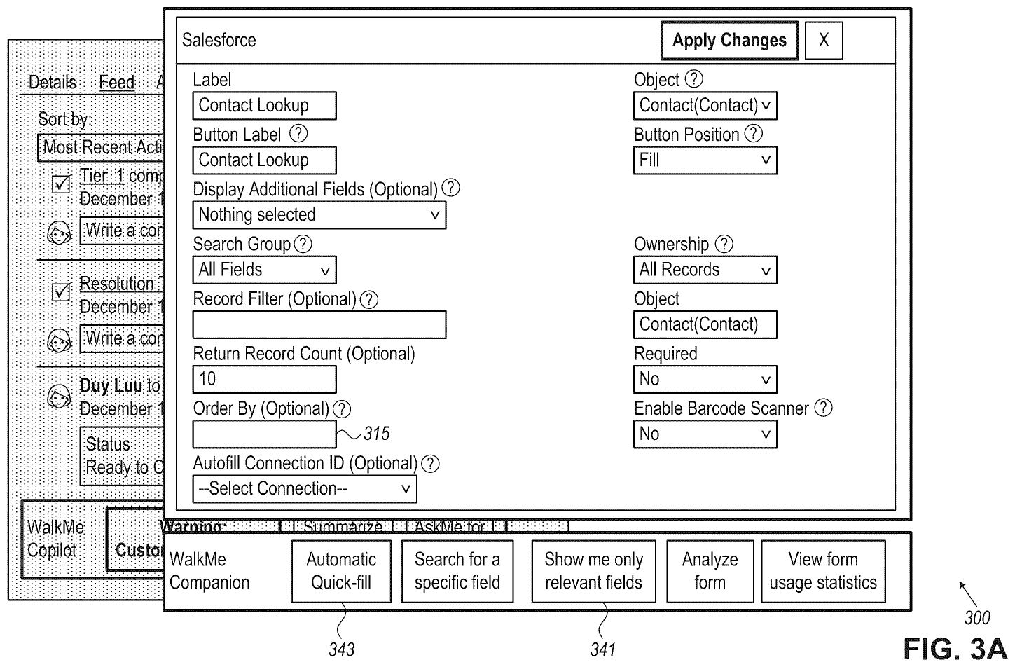

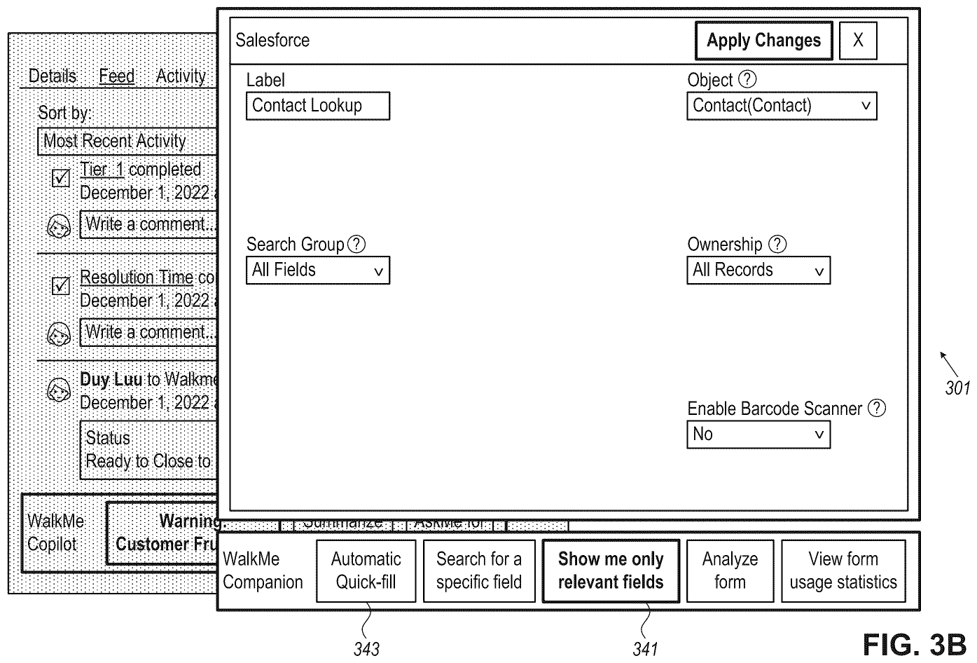

Referring now to FIGS. 3A-3B depicting exemplary execution of a deployed software assistant, in accordance with some exemplary embodiments of the disclosed subject matter.

In some exemplary embodiments, the software assistant may be used to assist end users with filling out forms. For example, the software assistant may be used to indicate to end users which fields are not mandatory, which fields are not important, to hide irrelevant parts of the form from end users (e.g., non-mandatory fields that are statistically correlated to high user frustration or failures), or the like.

For example, as depicted in FIG. 3A, an end user may execute on their end device a third-party application, and execute an assistance layer with a software assistance over the third-party application. In some exemplary embodiments, the third-party application may present to the user a GUI of the third-party application, such as Form 300. Form 300 may comprise a plurality of input fields that are intended to be filled out by the user, some of which being mandatory and some optional. In some exemplary embodiments, a defined software assistant may be executed on the display of the user, e.g., on Form 300, and determine whether one or more launchers should be displayed therein. In some exemplary embodiments, launchers may be displayed in case one or more identification events, defined for the launchers by the admin user via the DAP, are detected.

For example, in the case of FIG. 3A, Launchers 341 and 343 may be presented to the user, e.g., in response to detecting an identification event of detecting a form in the GUI of the user. In some exemplary embodiments, Launcher 341 may state: “Show me only relevant fields”, indicating that Launcher 341 is linked to an automation process configured to show the user only relevant fields of Form 300. In some exemplary embodiments, Launcher 343 may state: “Automatic Quick-fill”, indicating that Launcher 343 is linked to an automation process configured to automatically fill out fields of Form 300. For example, in the depicted scenario, the indication of the automation process may be provided by text, e.g., the terms presented by Launchers 341 and 343.

In some exemplary embodiments, Launchers 341 and 343 may be configured to execute the respective automation processes in response to one or more trigger events, e.g., a user selection of Launchers 341 and 343. For example, in case the user selects Launcher 341, which states: “Show me only relevant fields”, Form 301 of FIG. 3B may be presented to the user, in which all fields deemed irrelevant by the software assistance may be hidden from the user.

In some exemplary embodiments, Fields may be hidden by the automation process, such as by placing an overlay that hides the irrelevant fields from the user, by adjusting the layout of the page, or the like. For example, as depicted in FIG. 3B, in case Input Field 315 of FIG. 3A is deemed irrelevant by the software assistance, Form 301 may be generated to hide Input Field 315 from the form, thereby presenting to the user only fields deemed relevant.

In some cases, fields may be deemed irrelevant by the software assistance based on statistical data from the form that was gathered at the DAP. In some cases, fields may be deemed irrelevant as part of the automation process, e.g., by extracting the names and values of the form fields from Form 300 of FIG. 3A, generating a prompt to an LLM engine instructing the engine to determine which fields are irrelevant, and to hide fields of Form 300 based on the output from the LLM engine. It is noted that in some cases fields may be deemed relevant even if not mandatory.

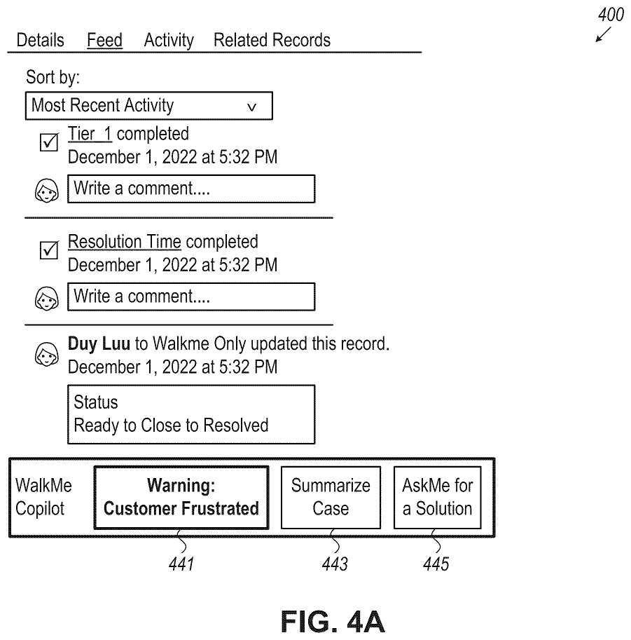

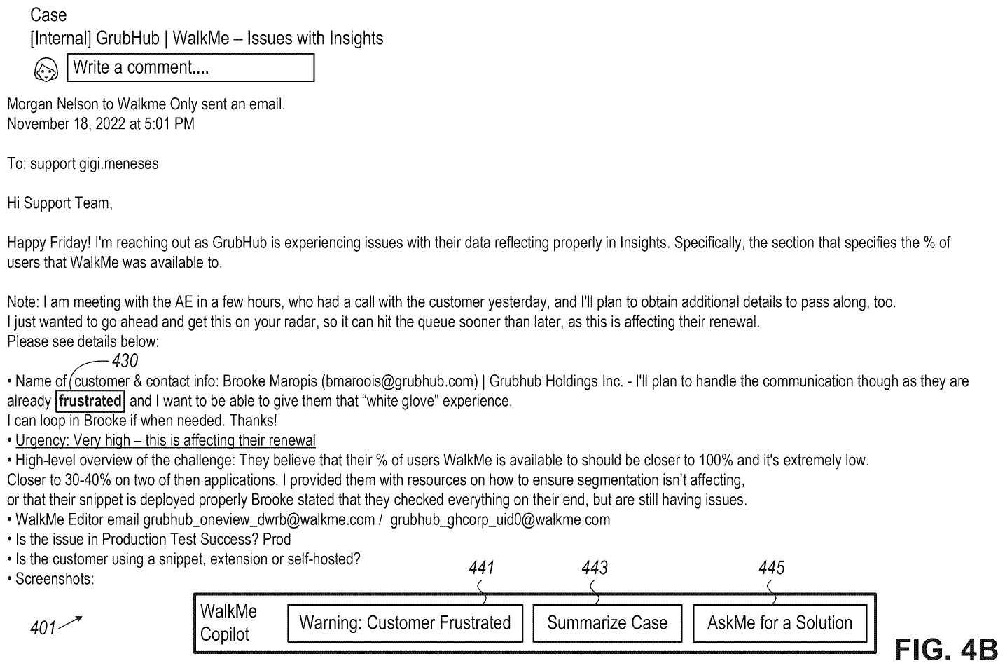

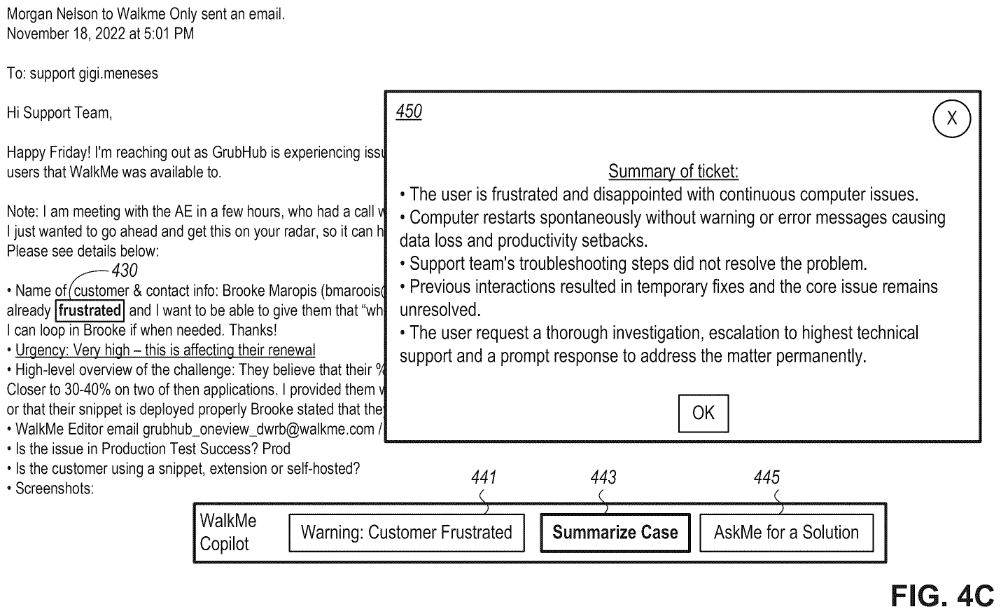

Referring now to FIGS. 4A-4C depicting exemplary execution of a deployed software assistant, in accordance with some exemplary embodiments of the disclosed subject matter.

In some exemplary embodiments, launchers of the software assistant may assist end users with performing a plurality of content-related digital tasks, text-based digital tasks, or the like, e.g., as depicted in FIGS. 4A-4C. In some exemplary embodiments, the software assistant may be used to assist end users, such as support agents, with reviewing submissions of forms (e.g., support tickets), emphasizing important parts, handling and solving issues with submitted forms, or the like. For example, a support ticket may comprise a ticket submitted by a customer of an organization, which is intended to be reviewed by a support agent of the organization, e.g., the end user. For example, a support ticket may indicate that the customer is or is not happy with a product of the organization.

For example, as depicted in FIG. 4A, an end user may execute on their end device a third-party application, and execute an assistance layer with a software assistance over the third-party application. In some exemplary embodiments, the third-party application may present to the user a GUI of the third-party application, such as GUI 400 depicted submitted support tickets that are intended to be reviewed and handled by the end user. In some exemplary embodiments, a defined software assistant may be executed on the display of the user, e.g., on GUI 400, and determine whether one or more launchers should be displayed therein. In some exemplary embodiments, launchers may be displayed in case one or more identification events, defined for the launchers by the admin user via the DAP, are detected (e.g., an automatic identification of the GUI as a support ticket, an automatic identification of an associated field, an automatic identification of a URL matching a support ticket platform (e.g., in a whitelist), or the like).

For example, in the case of FIG. 4A, Launchers 441, 443, and 445 may be presented to the user, e.g., in response one or more identification events. In some exemplary embodiments, Launcher 441 may state: “Warning: Customer frustrated”, indicating that Launcher 441 is linked to an automation process configured to emphasize or mark frustrated portions of support tickets. In some exemplary embodiments, Launcher 443 may state: “Summarize Case”, indicating that Launcher 443 is linked to an automation process configured to automatically summarize support tickets depicted in GUI 400. In some exemplary embodiments, Launcher 445 may state: “Ask Me For A Solution”, indicating that Launcher 445 is linked to an automation process configured to automatically generate a textual response or guidance on responding to the support tickets depicted in GUI 400.

In some exemplary embodiments, Launchers 441, 443, and 445 may be configured to assist end users with text analysis tasks, e.g., with reviewing and reading form submissions, which may be a tedious and time-consuming task. In some exemplary embodiments, a user (e.g., a support agent) may typically be required to review and analyze dozens of tickets a day, which may be challenging. For example, when faced with numerous form submissions, agents may be overwhelmed, increasing the likelihood of errors or oversights when attempting to enforce an organization's policy. In some exemplary embodiments, in order to assist support agents with text analysis tasks, launchers such as Launchers 441, 443, and 445 may be deployed to utilize LLM technology to enhance a process of reviewing form submissions, according to various use cases. For example, the process of reviewing form submissions may be enhanced by Launcher 443 providing summaries of the submitted text, Launcher 441 providing insights regarding the semantic properties of the submitted text and/or the sentiment of the text, Launcher 445 extracting action items from text and/or finding automatic answers for questions posed by the text, or the like.

In some exemplary embodiments, Launchers 441, 443, and 445 may be configured to execute the respective automation processes in response to one or more trigger events, e.g., a user selection of Launchers 441, 443, and 445.

For example, in case the user selects Launcher 441, which states: “Warning: Customer frustrated”, GUI 401 of FIG. 4B may be presented to the user, in which Relevant Portions 430 of a support ticket that is under review, are marked up and presented to the user.

For example, in order to markup Relevant Portions 430, the automation process of Launcher 441 may generate a prompt to an LLM engine, instructing the engine to find portions of the tickets that indicate frustration, to provide guidance to the user on handling the situation, to provide a suggested response to the negative support ticket, to provide advice for answering the negative support ticket, or the like. For example, the prompt may instruct the LLM engine to find portions of the tickets that indicate frustration, and the automation process may obtain from the LLM engine the respective locations, and mark them in GUI 401 using defined heuristic rules.

In some cases, Launcher 441 may be defined by an admin user in order to automatically identify a sentiment of a customer and alert the support agent in case of an extremely bad sentiment. Launcher 441 may be configured to be presented to the end user in case an initial automation process is executed on text of the GUI, and generates a prompt instructing an LLM engine to score the sentiment of the text. For example, the prompt to the LLM engine may state: “Provide me the sentiment of the following text. The result should be a number from 1 to 10 where 1 is a very bad sentiment and 10 is a very good sentiment”, or any other prompt. According to this example, the launcher and/or initial automation process may process the output from the LLM engine, and determine whether conditions of the identification event of Launcher 441 are complied with. For example, the identification event of Launcher 441 may define that the score of the negative sentiment must be less than a threshold (e.g., less than 3) in order to present Launcher 441 in the software assistant.

In one scenario, such as in case the user selects Launcher 443, which states: “Summarize Case”, the automation process of Launcher 443 may generate a prompt to an LLM engine with the text extracted from the support ticket, the prompt instructing the engine to summarize the text of the support ticket, to summarize a long thread of support tickets, a single support ticket, quarterly review goals, deal statuses, expense reports, sales processes, or the like. For example, the prompt to the LLM may state: “Please summarize the following text into up to five bullet points”. In some exemplary embodiments, the automation process may obtain from the LLM engine the summary, and present it to the user, such as via a balloon widget, tooltip, a popup window, an existing GUI element, by highlighting portions of the existing text in the page that correspond to the summary, or the like. For example, FIG. 4C depicts a scenario in which may be Summary 450 is presented to the user, in response to the user selecting Launcher 443 (after selecting Launcher 441).

In one scenario, such as in case the user selects Launcher 445, which states: “Ask Me For A Solution”, the automation process of Launcher 445 may generate a prompt to an LLM engine with the text extracted from the support ticket. For example, Launcher 445 may be configured to assist end users, such as Information Technology (IT) helpdesk users, to find quick solutions to customers' problems. In some exemplary embodiments, the prompt may instruct the LLM engine to find quick solutions to customers' problems, to generate a textual solution to a problem posed by the source data, to generate a response or guidance on responding to the support ticket, to find an answer in an internal or external Knowledge Base (KB) to a question posed by the support ticket, or the like. For example, the prompt may define a dataset or content source from which an answer to a question may be retrieved, e.g., stating: “answer question in *input text* based on content sources *1* and *2*”. According to this example, the prompt may configure the LLM to answer a question inputted by an end user based on two specified content sources, to which the LLM has access. For example, a content source may comprise a PDF document with company regulations, a website, a repository, a library, or the like. In some cases, the prompt may be generated to incorporate one or more guidance or solution rules from a content source such as a PDF document. As another example, the prompt may instruct the LLM engine to draft a suggested answer to the support ticket. The assistance layer may obtain from the LLM engine the proposed solution, and present it to the user, such as via the chat widget of the copilot, a balloon widget, tooltip, a dialog box, or the like.

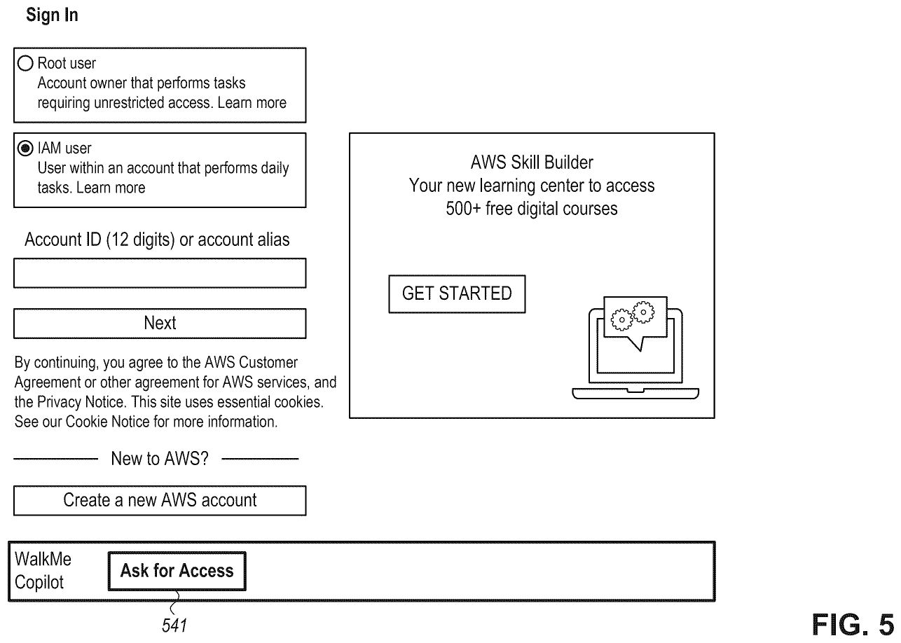

Referring now to FIG. 5 depicting an exemplary execution of a deployed software assistant, in accordance with some exemplary embodiments of the disclosed subject matter.

In some exemplary embodiments, the software assistant may be used to assist end users with account-related processes, such as signing in to an account, requesting access with different restrictions, or the like. For example, FIG. 5 depicts a login session into Amazon Web Services (AWS), in which the user may attempt to sign in as a “Root user” account with unrestricted access, such as in case of a fail to login to “IAM user” account used for daily tasks.

In some exemplary embodiments, Launcher 541 may be presented to the user, e.g., in response one or more identification events. For example, the identification event may comprise identifying that the GUI depicts a sign-in session, that the URL of the page relates to a sign-in session, that an account field is depicted in the GUI, that the user previously failed to login into the “IAM user” account, or the like.

In some exemplary embodiments, in response to the identification event, Launcher 541 may be presented to the user in the software assistant. For example, Launcher 541 may state: “Ask for access”, indicating that Launcher 541 is linked to an automation process configured to automatically handle the login session for the user, e.g., automatically request access to the “Root user” account instead of the user. In some exemplary embodiments, Launcher 541 may be configured to execute the respective automation processes in response to one or more trigger events, e.g., a user selection of Launcher 541.

In other cases, any other launchers associated with any other automation processes may be defined, deployed, and executed. For example, launchers may be defined to obtain text that the end user wrote and re-write it, e.g., to rephrase the text to a professional tone or any other selected tone, to change the tone to apologetic, or the like. For example, in response to an identification event in which an end user marks or selects text, such as text of an email, a launcher may appear in the software assistant, indicating that the launcher is configured to enhance the writing of the email, provide suggestions of revisions, or the like.

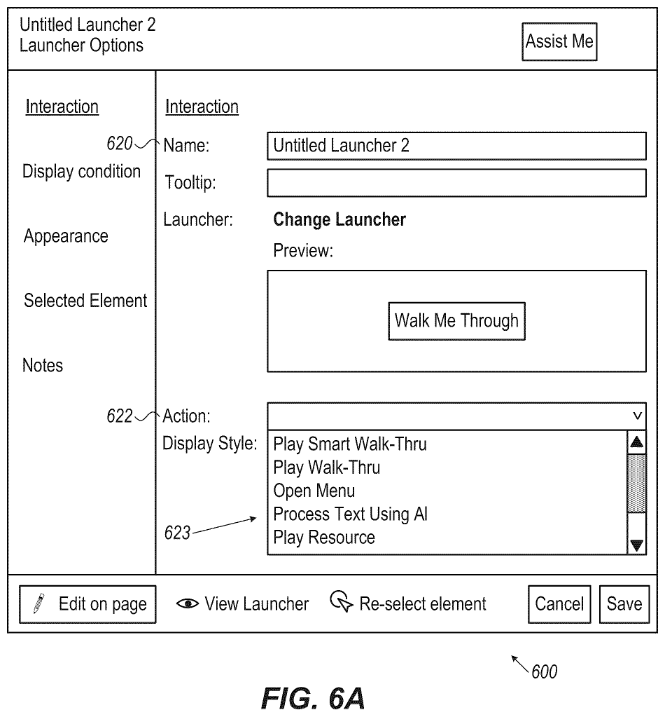

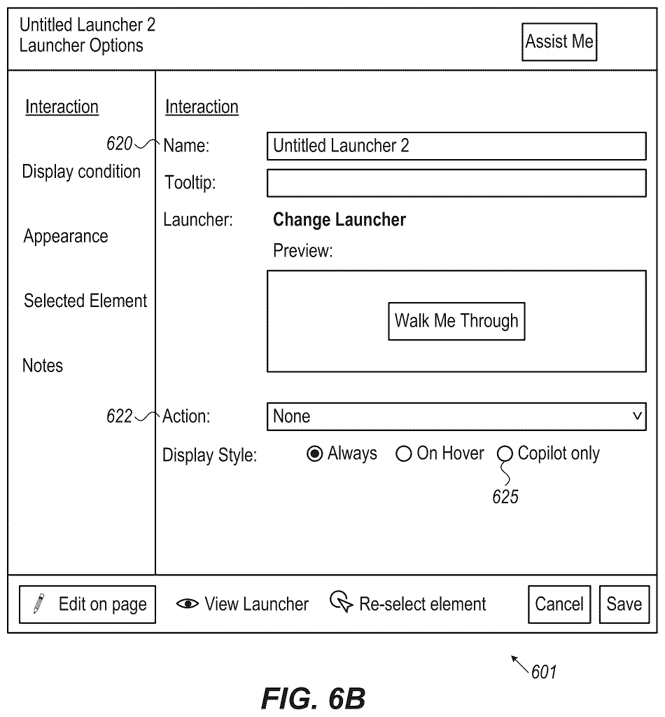

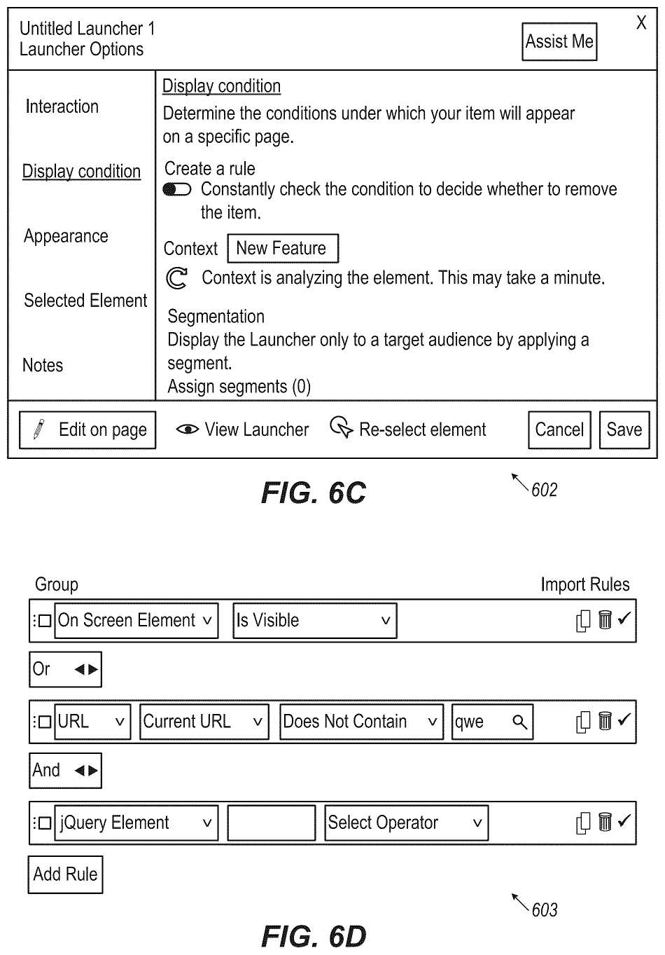

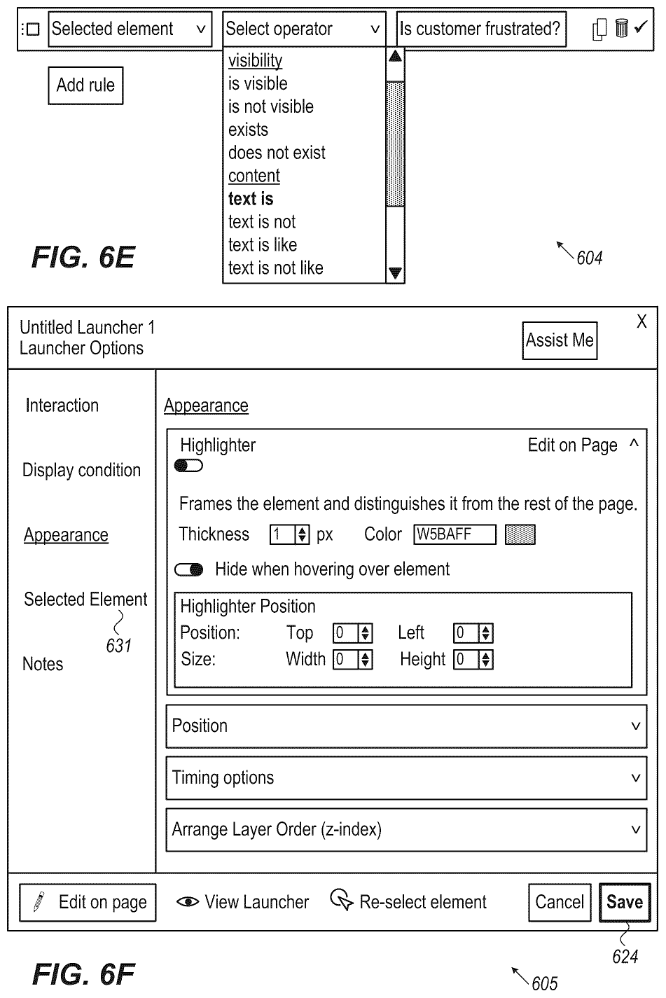

Referring now to FIGS. 6A-6F depicting an exemplary DAP editor, in accordance with some exemplary embodiments of the disclosed subject matter.

In some exemplary embodiments, in order to configure launchers of a software assistant, an admin user may execute an editor of a DAP system. In some exemplary embodiments, the editor may comprise a plurality of GUIs, pages, tabs, or the like, enabling end users to define desired configurations and properties of launchers. For example, FIGS. 6A-6F depict exemplary GUIs of such an editor. In some exemplary embodiments, in addition to executing the editor of the DAP, the admin user may execute a third-party application, system, or the like, over which the launcher is desired to be executed.

In some exemplary embodiments, defining the settings of a launcher may comprise defining an interaction of the launcher, e.g., an automation process thereof, defining display conditions of the launcher, e.g., an identification event, defining appearance configurations for presenting to the end user the launcher and/or the result of the automation process, selecting a GUI element from the third-party page to be associated with the launcher, or the like. In some exemplary embodiments, defining the settings of a launcher may comprise defining source data to be processed by the automation process. For example, the source data may comprise data of a specified element, user input to a specified element, selected text, all text in a display, or the like.

In some cases, the admin user may setup each launcher via a user interface such as GUI 600. For example, the admin user may customize the behavior and appearance of the launcher according to preferences or policy requirements of a specific organization, a third-party system over which the launcher is configured to be executed, or the like. In some exemplary embodiments, via GUI 600, the admin user may define a name of a launcher, e.g., preferably indicating the intended functionality of the launcher. For example, the admin user may insert the desired Name 620 into the adjacent text field via a keyboard, a touchscreen, a vocal command, or the like.

In some exemplary embodiments, the admin user may define the interaction of the launcher by defining one or more interactions or automation processes that are configured to be performed by the launcher. In some exemplary embodiments, the automation process may be selected from a set of pre-set automation processes, defined from scratch via the DAP, or the like. In some cases, selecting a pre-set automation process from a set of pre-set automation processes, may cause one or more other settings of the launcher to be set automatically, e.g., according to default settings of the process.

As depicted in FIG. 6A, the field Action 622 enables the user to select one or more desired types of automation processes from a list of possibilities. A selected type of automation process may be used by the created launcher. In some exemplary embodiments, the list may comprise heuristic-based processes, content-based processes, or the like. For example, LLM Process 623 (denoted “Process text using AI”) may represent content-based automation processes that utilize an LLM. In some exemplary embodiments, content-based processes may comprise performing text generation tasks, text analysis tasks, or the like, while heuristic-based processes may comprise playing a walkthrough, rendering a resource such as a media file, or performing any other operation that does not require LLM technology. For example, heuristic-based processes may be defined based on non-LLM rules such as regular expressions, syntactical constraints, or the like.

In some exemplary embodiments, in case a content-based automation process is selected, the admin user may select a desired text generation task, text analysis task, or the like, from a list of preconfigured tasks, or define the task using natural language text. For example, available text generation tasks may comprise a summarizing task, a “change tone” task, a task of transforming bullet points to text task, or the like, and such tasks may or may not be customized, adjusted, or the like (e.g., by adjusting a defined prompt to the LLM, the source data, or the like).

In some exemplary embodiments, the admin user may associate the launcher with a software assistant such as a copilot. In some cases, as depicted in GUI 601 of FIG. 6B, the admin user may select to associate the launcher with a copilot. For example, the copilot association may made by selecting Copilot Mode 625 from a “Display Style” field, a respective dropdown element, or the like. In such cases, the launcher that is being designed by the admin user may only be presented within a copilot bar of the copilot. In other cases, the admin user may configure the launcher as an independent launcher that is not associated with a software assistant. For example, in such cases, the launcher may be presented adjacently to a page element with which it is associated. For example, an independent launcher may be presented in response to an identification event, always, on hover, or the like.

In some exemplary embodiments, FIG. 6C depicts display configurations for the launcher, which may be defined by the admin user. In some exemplary embodiments, the admin user may define, such as via GUI 602, display conditions of a launcher. In some exemplary embodiments, the display conditions may comprise one or more identification events, which, when identified, should cause the launcher to be presented and displayed to the end user. For example, the launcher may be configured to be displayed when the display conditions are met, e.g., based on the context of the GUI displayed to the user, detected elements, detected user interactions of one or more types, or the like. In some exemplary embodiments, GUI 602 may enable the admin user to select a frequency of polling the identification events, a segmentation of the launcher, or the like. For example, the launcher may be configured to perform a different operation for different user segments of end users, to be displayed based on such user segments, or the like.

In some exemplary embodiments, the identification events may be defined by the admin user using a rule engine with one or more regular expressions, syntactical constraints, or the like, e.g., as depicted in GUI 603 of FIG. 6D. For example, as depicted in FIG. 6D, an identification event may be defined based on determining whether a specified page element (e.g., HTML element) is visible in the screen of the end device, based on a URL of the rendered page complying with one or more conditions (e.g., a whitelist, a scripted text string, or the like), based on an on-screen element complying with one or more conditions, based on a jQuery element complying with one or more conditions, based on user data provided by the user complying with one or more conditions, or the like. In some exemplary embodiments, an identification event may be defined to comprise one or more logical relations between two or more rules or conditions.

For example, the admin user may define, via User Interface 603, a first context-based rule defining that a specified GUI element must be visible, a second context-based rule defining that the page URL may not comprise a specified text string, and a third context-based rule defined with respect to a jQuery element. In some exemplary embodiments, any other number of context-based rules may be defined as the identification event. In some cases, the relationship between context-based rules may be defined by the admin user, such as by determining a logical ‘or’ relationship between certain rules (requiring one of the rules to be complied with), a logical ‘and’ relationship between certain rules (requiring both rules to be complied with), or the like, such as in case the entire set of rules is complied with, the launcher will be presented to the end user according to the configuration of FIG. 6B.

In some exemplary embodiments, in addition to defining the identification events using one or more regular expressions, syntactical constraints, or the like, one or more LLM-based rules may be used to define identification events. In some exemplary embodiments, the DAP editor may enable users to define launchers to utilize LLM technology for defining the identification events. In some exemplary embodiments, LLM-based rules may be configured to generate a prompt to an LLM engine, and determine whether the identification event occurred based on an output from the LLM engine. In some exemplary embodiments, LLM-based rules may comprise content-based conditions that must be complied with in order to cause a launcher to be presented to an end user.

In some exemplary embodiments, LLM-based rules may comprise a condition relating to text from the GUI of end users, and to one or more text strings provided by the admin user. For example, as depicted in GUI 604 of FIG. 6E, a rule may be defined by the admin user to present a launcher in case text in the GUI (e.g., selected text, all text, text entered by the end user, text of a specific element) is similar to a command provided by the admin user, is dissimilar to the command, complies with one or more conditions of the command, is identical to the command, has a logical relationship with the command, or the like.

For example, a rule may be defined for a selected element (e.g., a jQuery element) to present a launcher based on a “Yes/No Question (AI)”. The rule may be complied with if the text of the selected element complies with a “Yes/No Question” scripted by the admin user, such as “Is customer frustrated?”. For example, text from the GUI of the end user may be extracted, and used to generate a prompt asking the LLM engine whether the command “Is customer frustrated?” is complied with by the extracted text. In case the answer from the LLM engine is positive, the launcher may be presented, and vice versa. In other cases, any other content-based rules may be defined as identification events, e.g., using natural language free text from the admin user as the command.

In some exemplary embodiments, appearance or presentation configurations of the launcher may be defined, e.g., according to GUI 605 of FIG. 6F. In some exemplary embodiments, the admin user may define display, via User Interface 605, the appearance configurations of the launcher, the appearance configurations of results of the automation process, or the like. For example, appearance configurations may define a text string presented by the launcher, a color or other visual effects of the text string, an image presented by the launcher, a different GUI element presented by the launcher, or the like. As another example, the appearance configurations may define an element in which results from the automation process should be presented, a layout change configured to present results from the automation process, a configuration for generating a result based on outputs from the automation process, or the like.

In some exemplary embodiments, as depicted in FIG. 6F, the appearance configurations of the launcher may define whether or not the launcher and/or result should be highlighted compared to the GUI, and visual properties of the launcher and/or result such as the color thereof, a thickness thereof, a position thereof, interaction settings thereof, or the like.

In some exemplary embodiments, the appearance configurations of the launcher may define how a result of the automation process should be presented to end users. For example, the result may be configured to be concatenated to a text field, to replace text in a text field, to replace an image with a second image, to change a layout of the GUI, to display a launcher as an overlay over the GUI, or the like.

In some exemplary embodiments, in case the launcher is defined as part of a copilot, such as according to FIG. 6B, the position of the launcher may be automatically set to be incorporated into a copilot bar. In some exemplary embodiments, in case the launcher is not part of a copilot, the admin user may be enabled to define a position of the launcher via GUI 605 of FIG. 6F.

In some exemplary embodiments, the admin user may define any other settings of the launcher. For example, via Menu Tab 631, the admin user may be enabled to define a selected element of the GUI of the third-party application, which may be associated with the launcher.

In some cases, an element that is associated with a launcher may refer to an element from which source data is extracted to be processed by the automation process of the launcher. As another example, via Menu Tab 631, or any other GUI of the DAP editor, the admin user may define a trigger event for activating the automation process of the launcher.

In some exemplary embodiments, after the admin user completes the launcher definition stage, the admin may save the configurations, e.g., using a Save 624 button or in any other way, thereby generating a record of the desired launcher, incorporating the desired launcher within a generated assistance layer, or the like. In some exemplary embodiments, a generated assistance layer that incorporates the defined launcher may be distributed to end devices, made accessible thereto, or the like, thereby enabling end devices to execute the launcher over the third-party application. For example, the assistance layer may be distributed to end devices, embedded in the pages of the third-party application, incorporated as an update within browser extensions of the end devices, or the like.

In some exemplary embodiments, launchers may be categorized into different types, such as action launchers, menu launchers, tag launchers, structures launchers, or any other type of launcher. In some exemplary embodiments, when defining and/or generating a launcher, the admin user may select a type of the launcher from the different categories, may use a default category, or the like. For example, action launchers may correspond to the launchers of FIGS. 2C-5. As another example, menu launchers may comprise menu tabs that represent a plurality of launchers. For example, a general task may be represented as a menu tab, and upon selection, one or more launchers for subtasks may appear. In other cases, any other levels of nesting may be used for menu launchers, e.g., three layered nesting, four layered nesting, or the like. In some cases, the levels of nesting may correspond to a tree data structure, where the non-leaf nodes represent general ‘menu’ tasks and the leaves represent launchers implementing subtasks of the menu nodes.

In some exemplary embodiments, one category of launchers may comprise structured launchers (or structured summary launchers). In some exemplary embodiments, structured launchers may refer to a category of launchers that are defined to incorporate a structure of multiple tags, items, sub-launchers, or the like. In some exemplary embodiments, tags of a structured launcher may represent sub-tasks that together constitute a full task of the structured launcher. For example, a structured launcher may be viewed as a ‘parent’ launcher and its tags may be viewed as ‘child’ launchers. According to this example, the ‘parent’ launcher may be configured to present outcomes of the tags in a window overlay, or any other widget.

In some exemplary embodiments, the admin user may define (via the DAP) an identification event for the ‘parent’ launcher that may be shared by all of its tags. In some exemplary embodiments, the admin user may define for each tag a respective automation process, source data, title, or the like. For example, the source data of each tag may correspond to a section of an opportunity page, and the title of each tag may comprise the section's name. In other cases, any other division may be set between shared properties and non-shared properties of the tags.

In one scenario, a structured launcher, such as an “Analyze Risk” launcher, may be configured to analyze opportunity pages, analyze risks indicated by opportunity pages, suggest solutions to identified risks, or the like, and provide a summary of the insights to end users. In order to reduce the complexity of such a process, the admin user may define a structure of a plurality of tags for implementing sub-tasks of the “Analyze Risk” launcher. In some cases, each tag may correspond to a different section of an opportunity page. For example, a first tag may be defined to extract and analyze data from a “Next Steps” section of an opportunity page, a second tag may be defined to extract and analyze data from a “Support Engineer (SE) comments” section of an opportunity page, a third tag may be defined to extract and analyze data from a “Risk Detected Reason” section of an opportunity page, or the like. For example, the admin user may select sections that are estimated to be relevant to the task, and generate tags for them. In other cases, different tags may be defined for a same section, a same tag may be defined for a plurality of sections, or the like.

According to the above scenario, the admin user may define (via the DAP) a single identification event for all tags of the “Analyze Risk” launcher, e.g., identifying an opportunity page. In some exemplary embodiments, for each tag, the admin user may define its source data, an automation process (e.g., a prompt to an AI engine), a name or title, or the like. For example, the admin user may define the source data of a tag as a specified section of the opportunity page, a plurality of sections of the page, all data in the page, or the like.

In some exemplary embodiments, one or more automation processes such as prompts to AI engines may be defined, by the admin user, for each tag of the “Analyze Risk” launcher. In some cases, each tag may be associated with a separate prompt, or two or more tags may be associated with a same prompt (e.g., associated with different sections).

For example, a unique prompt may be defined for a tag associated with a “Risk Detected Reason” section of an opportunity page (e.g., as source data). According to this example, the prompt may instruct an AI engine to identify a risk in text of the “Risk Detected Reason” section (e.g., as submitted by a prospect), and to summarize the risk if one is identified.

As another example, a unique prompt may be defined for a tag associated with a “Next Steps” section of an opportunity page (e.g., as source data). According to this example, the prompt may instruct an AI engine to summarize an identified risk in the section, and briefly suggest, in 1-3 points, actions the sales representative can take to mitigate the risk (“using the text in the next steps section, summarize the identified risk and briefly suggest, in 1-3 points, actions the sales representative can take to mitigate the risk. A risk can include indications of competition, dissatisfaction with the proposed solution or price, involvement in another project, potential purchase delays, or similar concerns”).

As another example, a unique prompt may be defined for a tag associated with a “SE comments” section of an opportunity page (e.g., as source data). According to this example, the prompt may instruct an AI engine to summarize an identified risk in the SE comments section. In some cases, the prompt for the “SE comments” section may be identical to the prompt for the “Risk Detected Reason” section. In other cases, the prompt may be unique and different from other prompts.

In some exemplary embodiments, after defining a prompt for each tag of the “Analyze Risk” launcher, an assistance layer incorporating the launcher may be executed over a GUI of the third-party application on an end device of an end user, and the GUI may be monitored to determine whether the identification event occurred (e.g., whether the GUI renders an opportunity page). In some cases, an occurrence of the identification event may cause one or more respective launchers to be displayed in a copilot bar, e.g., the “Analyze Risk” launcher. For example, the “Analyze Risk” launcher may appear as a menu tab, as a sub-task of a menu tab, or the like, within the copilot bar.

In some exemplary embodiments, in case an end user selects or interacts with “Analyze Risk” launcher (e.g., a trigger event), the automation processes of the launcher's tags may be executed, e.g., simultaneously. For example, an execution of a first tag may cause the AI engine to extract and/or analyze text from the “Next Steps” section of the opportunity page, summarize an identified risk in the section, and briefly suggest, in 1-3 points, actions the sales representative can take in order to mitigate the risk. For example, the AI engine may determine, based on the text in the “Next Steps” section, that the prospect lacks a confirmed timeline (as the risk), and suggest mitigation actions such as scheduling follow-up meetings to address the risk.

As another example, a simultaneous execution of a second tag may cause the AI engine to extract and/or analyze text from the “SE comments” section of the opportunity page, and summarize an identified risk in the section.

As another example, a simultaneous execution of a third tag may cause the AI engine to extract and/or analyze text from the “Risk Detected Reason” section of the opportunity page, identify risk factors in the text, and to generate a summary of the risk information. For example, the AI engine may determine that the text in the respective section includes risks of competition, timeline and compatibility, and summarize such risks as: “Indication of Competition & Timeline issue & Compatibility issue”.

In some cases, the executions of the tags' automation processes may be simultaneous, have overlapping timeframes, may be sequential, or the like. In some exemplary embodiments, outputs of the AI engines for all automation processes of all tags may be accumulated and presented to the end user, e.g., as a window overlay or in any other convenient format. For example, a name of each tag may be presented as a section of the window overlay, and an output of the tag's automation process may be presented below. In some cases, the outputs may be presented in a window such as in the co-pilot's chat widget, helping an end user such as a sales representative to understand the risks and suggested actions quickly and efficiently. In other cases, outputs may be presented in any type of widget, tooltip, or the like, together or separately.

In some cases, the window may comprise a general task section (e.g., above the tags' outputs), describing the task that is addressed by the tags. For example, for the “Analyze Risk” structured launcher, the general task section may state: “A risk has been detected in this opportunity. Here is our analysis”, indicating that the tags are used to evaluate risks in the opportunity page.

In some exemplary embodiments, outputs may be presented with or without a “highlight” control. For example, an output from a tag may be presented adjacently to a “highlight” control, which may be configured, when selected by the user, to navigate and highlight the data source of the respective tag within the opportunity page. In other cases, the “highlight” control may highlight any other section of the opportunity page, e.g., sections that were determined to be significant or related to the tag by the AI engine.

In some exemplary embodiments, another category of launchers may comprise tag launchers. In some exemplary embodiments, tag launchers may correspond to structured launchers, in which the source data of each tag is not limited to a section of an opportunity page, and the general task relates to certain criteria. Tag launchers may be used for scenarios in which the goal is to evaluate whether complex criteria are complied with by source data. For example, a “Can I Change Stage” launcher may constitute a tag launcher configured to determine whether the current stage of a sales opportunity, as represented by a rendered opportunity page, complies with a plurality of factors that are required in order to move to a next stage in the sales process.

In some exemplary embodiments, tag launchers may rely on multiple factors, which may, in turn, rely on multiple data sources. In some exemplary embodiments, in order to provide such complex functionality, a tag launcher may be defined by an admin user to incorporate multiple tags, items, sub-launchers, or the like. The tags may also be referred to as items. For example, each tag may correspond to a different criterion of the “Can I Change Stage” launcher, and executing all the tags may cause the AI engine to determine whether the criteria for advancing the stage of the sales process, as defined by the admin user, is complied with.

In some exemplary embodiments, the defined tags of the launcher may be configured to extract and process content. In some exemplary embodiments, a tag may correspond to a sub-launcher, and may or may not be configured to extract source data from one or more defined sections of the opportunity page (or any other GUI). For example, each tag of the launcher may comprise different source data, one or more tags may have overlapping source data, or the like. In some cases, the admin user may define one or more prompts for each tag, define source data for each tag, select a number of tags for each complex launcher, or the like.

For example, the admin user may define a launcher to incorporate a plurality of tags, e.g., a “Contacts” item, a “Competition” item, a “Next Steps” item, a “Non-Disclosure Agreement (NDA)” item, or the like. In some exemplary embodiments, the admin user may define a unique prompt for each item.

For example, the admin user may define a prompt for the “Contacts” item, instructing the AI engine to extract information about contacts from the opportunity page, to determine whether any contacts are described, and to generate a summary that lists any identified contacts (“do contacts exists? If they do, please list them”).

As another example, the admin user may define a prompt for a “Competition” item, instructing the AI engine to extract text from one or more specified sections such as the “Next Steps” section in the opportunity page, analyze the text to determine if the text relates semantically to a competition, and summarize the text in case it does relate to a competition (Is competition mentioned in the “Next Steps” section?”).

As another example, the admin user may define a prompt for a “Next Steps” item, instructing the AI engine to extract text from one or more specified sections such as the “Next Step” section in the opportunity page, analyze the text to determine if the section was populated by an end user, and summarize the text in case it was populated (“is the “Next Steps” section complete? If so, summarize”).

As another example, the admin user may define a prompt for an “NDA” item, instructing the AI engine to extract text from one or more specified sections such as an “NDA needed” section in the opportunity page, analyze the text to determine if the section was populated by an end user, and in case it was not populated, instruct the end user to populate the section (“is the “NDA needed” field completed? If not, output: Please indicate if an NBA is needed by selecting Yes or No in the NDA Needed field”).

In some exemplary embodiments, after defining a prompt and/or source data for each item, an assistance layer that incorporates the tag launcher may be executed over a GUI of the third-party application on an end user device, and the GUI may be monitored to determine whether the identification event occurred (e.g., whether the GUI renders an opportunity page, or any other defined event).

In some cases, an occurrence of the identification event may cause one or more respective launchers or menu bars to be displayed in a copilot bar, e.g., a launcher such as the “Can I Change Stage” launcher. In some exemplary embodiments, in case an end user selects or interacts with the “Can I Change Stage” launcher, the automation processes of all of the items defined by the launcher may be executed. For example, the prompts of the items may be generated, provided to one or more AI engines (as a single execution of aggregated prompts or as a plurality of separate executions), and the outputs may be presented in one or more manners.

In some exemplary embodiments, outputs from the AI engine may be configured to be presented to the end user, e.g., as a window overlay or in any other convenient format, as a highlighting of portions of the GUI, or the like. For example, the outputs may assist a sales representative to understand how to move on to a next stage, what criteria is not complied with, what criteria is complied with, or the like. In some exemplary embodiments, a name of each tag may be presented in a tag section of the window overlay, and in response to a selection of the tag's name, an output of the tag's automation process may be presented in an output section of the window overlay (e.g., a section of the window below the tag section). In some cases, outputs may be pre-calculated a-priori and presented in response to tag selections, or may be calculated on-the-fly (a posteriori) in response to each tag selection. According to this example, users may be enabled to navigate between the items, by selecting the respective tags in the tag section of the window. In other cases, the outputs may be presented in any other way, such as in separate windows, in a single window, or the like.

In some cases, the window may comprise a general criteria section (e.g., above the tag section), describing the complex criteria that is addressed by the tags. For example, for the “Can I Change Stage” tag launcher, the general criteria section may state: “Let's check if this opportunity is ready for stage number two. See the results in the tags below”, indicating that the tags are used to evaluate whether the current stage of a sales opportunity complies with criteria that is required in order to continue to a next stage in the sales process.

In some cases, compliance with a criterion of a tag may or may not be indicated by a visual cue. For example, tags that comply with a criterion may be presented with a green color for correct input, checkmarks, or the like. As another example, tags that do not comply with a criterion may be represented with a red color, a cross mark, or the like. In some cases, in case of a tag is not related to compliance with a criterion, one or more neutral visual cues may be presented, e.g., a grey color.

According to the above example, in case the identification event is identified, the defined prompts for the Contacts, Competition, Next Steps, and NDA items may be generated and provided to an AI engine such as an LLM. Selecting a first tag (the “Contacts” tag) in the tag section presents an output of the “Contacts” item in the output section, selecting a second tag (the “Competition” tag) presents an output of the “Competition” item, selecting a third tag (the “Next Steps” tag) presents an output of the “Next Steps” item, and selecting a fourth tag (the “NDA” tag) presents an output of the “NDA” item. In some exemplary embodiments, an end user may navigate between the items, by selecting the respective tags in the tag section.

For example, the user may select the “Contacts” tag in the window overlay, which may list identified contacts from the opportunity page (“Proposal Contact James Dale’ ‘Billing Contact: James Dale”). In some cases, the “Contacts” item may be defined to comprise a criterion, e.g., relating to whether or not any contacts are described in the opportunity page. For example, compliance with the criterion (the existence of contacts in the page) may be required in order to move to a next stage in the sales process. According to this example, compliance with the criterion may be indicated by one or more visual cues of the tag, such as a green color, a checkmark, or the like, while non-compliance may be indicated by a red color, a cross mark, or the like.

As another example, the user may select the “Competition” tag in the window overlay, which may present to the user a summary of text related to competition from the “Next Steps” section in the opportunity page (“Competitive environment is uncovered successfully”, “Main Competitor(s): ACME Corp”, and “Value: Superior Customer Service I 24-7 Support”). In some cases, the “Competition” item may be defined to comprise a criterion, e.g., relating to whether or not a competition is mentioned in the “Next Steps” section of the opportunity page, and corresponding visual cues may be presented as a design of the tag. According to this example, compliance with the criterion (the existence of contacts in the page) may or may not be required in order to move to a next stage in the sales process.

As another example, the user may select the “NDA” tag in the window overlay, which may present to the user an instruction to populate the “NDA needed” section in the opportunity page in case it was not populated (“Please indicate if an NDA is needed by selecting Yes or No in the NDA Neededfield”). In some cases, the “Competition” item may be defined to comprise a criterion, e.g., relating to whether or not the “NDA needed” section was populated, and corresponding visual cues may be presented as a design of the tag. According to this example, the instruction to populate the “NDA needed” section may assist the user with understanding what action is required in order to move to a next stage in the sales process, in case of non-compliance.

As another example, the user may select the “Next Steps” tag in the window overlay, which may present to the user a summary of the “Next Step” section in the opportunity page, in case it was populated (“A Discovery call was scheduled and SE invited. you're all set here!”, and “A call is scheduled with prospect on 28 Jul. 2024 to discuss their challenges and needs, with the SE available to address technical concerns and provide a brief demo”). In some cases, the “Next Steps” item may be defined to comprise a criterion, e.g., relating to whether or not the “Next Step” section was populated, and corresponding visual cues may be presented as a design of the tag. According to this example, compliance with the criterion (the “Next Step” section being populated) may or may not be required in order to move to a next stage in the sales process.

In some cases, tag launchers may be configured with any type of criteria, including semantic criteria, regular expressions, syntactical constraints, or the like, and compliance with the criteria may be evaluated by an AI engine according to defined prompts. For example, the criterion for the “Next Step” section may be defined to be complied with only if the text entered to the section matches certain regulations, has sufficient detail, or the like, which may be based on the content of the text and not only on its absence or presence.

In some exemplary embodiments, items may be presented with or without a “highlight” control (e.g., a button), e.g., in the output section of the window, in the tag section, or in any other section of the window. In some exemplary embodiments, the “highlight” control of a tag may be configured, when selected by the user, to highlight the data source of the tag within the opportunity page. In other cases, the “highlight” control may highlight any other section of the opportunity page, e.g., sections that were determined to be significant or related to the tag by the AI engine.

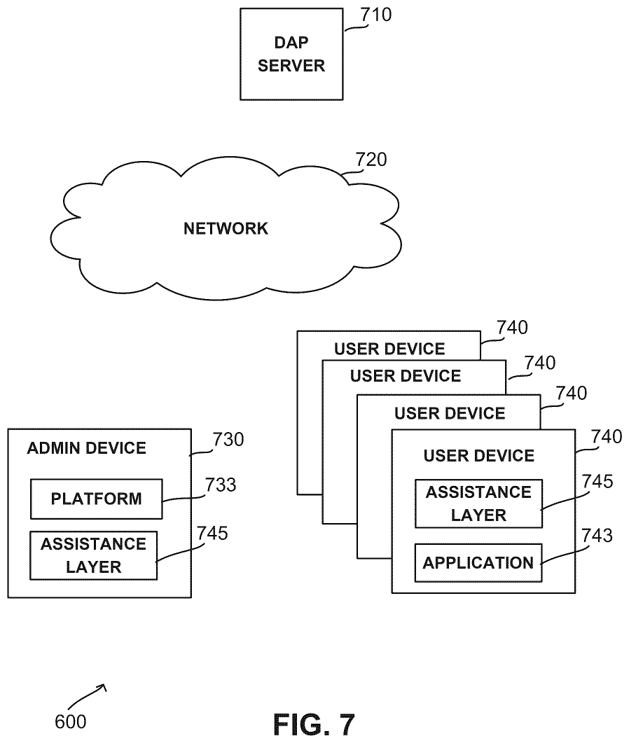

Referring now to FIG. 7 showing a schematic illustration of an exemplary environment, in accordance with some exemplary embodiments of the disclosed subject matter.

In some exemplary embodiments, Environment 700 may comprise a plurality of User Devices 740. User Devices 740 may comprise Personal Computers (PCs), stationary computers, tablets, smartphones, or any other end devices, of respective end users. User Devices 740 may be connected to a Computerized Network 720, such as a Wide Area Network (WAN), a Local Area Network (LAN), a wireless network, the Internet, an intranet, or the like.

In some exemplary embodiments, User Devices 740 may deploy and execute a third-party application, program, or the like, e.g., Application 743. For example, Application 743 may comprise a SALESFORCE™ application, Zendesk™, or the like. In some exemplary embodiments, Application 743 may comprise web page, a web application, a browser extension, a mobile application, a desktop application, or the like. In some exemplary embodiments, Application 743 may display to an end-user one or more screens, constituting a GUI, which may comprise one or more GUI elements. For example, User Devices 740 may execute a platform tailored to specific industries, such as for customer support, and the end users using User Devices 740 may be support agents. In other cases, User Devices 740 may execute any other type of application for any other purpose, industry, or the like.

In some exemplary embodiments, Environment 700 may comprise an Administrator Device 730 (denoted “admin device”), operated by an administrator user or another user with suitable credentials and permissions. In some exemplary embodiments, Administrator Device 730 may comprise an end device, similar too User Devices 740, and may be connected to Computerized Network 720.

In some exemplary embodiments, Administrator Device 730 may deploy, execute, or the like, Platform 733 and Target Application 743 (not depicted in Administrator Device 730). For example, Platform 733 may comprise a software platform, such as a DAP platform, that is configured to enable users to generate an assistance layer, e.g., Assistance Layer 745 over Target Application 743. For example, Assistance Layer 745 may be generated to comprise a software assistant such as a copilot for third-party applications such as Target Application 743 executing on User Devices 740. In some exemplary embodiments, the admin user may define, via Platform 733 of Administrator Device 730, one or more launchers to be included and activated by the copilot that is executed over Target Application 743.

In some exemplary embodiments, the launchers may be defined to have a plurality of settings, configurations, or the like, such as identification events that cause the launchers to appear in the copilot bar, trigger events that cause automation processes to be executed, the operations of the automation processes, presentation configurations for presenting outputs, or the like.

In some exemplary embodiments, defined launchers in Assistance Layer 745, may be made available to User Devices 740, either independently or via the copilot bar. For example, Assistance Layer 745 may be generated as a program product executable by a computer, such as, without limitations, a script, a software, a browser extension, a mobile application, a web application, a Software Development Kit (SDK), a shared library, a Dynamic Link Library (DLL), a SaaS, or the like, which may incorporate or have access to a copilot engine. According to this example, Assistance Layer 745 may be defined by the admin user and provided to User Devices 740 by sending the program product to User Devices 740. As another example, Assistance Layer 745 may be made available to User Devices 740 via API calls to a cloud or server storing the defined launchers, e.g., DAP Server 710. As another example, Assistance Layer 745 may be made available to User Devices 740 via updates to an existing application or software agent deployed by User Devices 740.

In some exemplary embodiments, at least one User Device 740 may execute corresponding Assistance Layer 745, Target Application 743, or the like, e.g., simultaneously. In some exemplary embodiments, Assistance Layer 745 may be executed over Target Application 743, and may enable users of User Device 740 to obtain contextual assistance when performing digital tasks on Target Application 743.

In some cases, User Devices 740 may execute a software agent (not depicted) associated with Assistance Layer 745. For example, the software agent may be configured to acquire GUI elements appearing in GUIs of Target Application 743, communicate the acquired data to a server such as DAP Server 710, and apply Assistance Layer 745 over the GUI according to data from DAP Server 710. In some cases, the software agent may correspond to one or more software agents disclosed in U.S. Pat. No. 10,620,975, entitled “GUI Element Acquisition Using A Plurality Of Alternative Representations Of The GUI Element”, dated Apr. 14, 2020, which is incorporated by reference in its entirety for all purposes without giving rise to disavowment. As another example, Assistance Layer 745 may be executed independently, without relying on DAP Server 710.

For example, an identification event may be identified by an agent executed over User Device 740, e.g., by monitoring the screen of User Device 740 and determining that the conditions defined for the identification event are met by the GUI of Target Application 743. Upon identifying the data from the user, a respective launcher may be presenting in the copilot bar, enabling end users to execute respective automation processes by interacting with the launchers. A result or output from an automation process may be presented to a user of User Device 740 according to configurations of the Assistance Layer 745, thereby assisting the user with performing digital task.

In some exemplary embodiments, DAP Server 710 may be connected to Computerized Network 720. DAP Server 710 may be connected directly, indirectly, or the like, to Administrator Device 730, to User Devices 740, or the like, such as via Computerized Network 720. In some exemplary embodiments, DAP Server 710 and Administrator Device 730 may or may not be implemented by the same physical device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for configuring a software assistant, the software assistant is configured to be executed as an overlay over a third-party application, the third-party application is executable on a plurality of end devices of end users, the method comprising:
defining an identification event associated with a Graphical User Interface (GUI) of the third-party application, the identification event is defined based on one or more conditions associated with a page context of the GUI;
defining that, in response to an occurrence of the identification event, a launcher associated with an automation process is configured to be automatically presented in the software assistant over the GUI;
defining source data associated with the automation process, the source data comprising at least a portion of text presented in the GUI, wherein the automation process is configured to process the source data;
configuring the software assistant to, in response to an occurrence of a trigger event associated with the launcher, automatically execute the automatic process, the automatic process is configured to process the source data and output a result; and
defining a configuration for presenting an output in the GUI, the output is determined based on the result of the automation process.

2. The method of claim 1, wherein the automation process comprises:
automatically generating a prompt for an Artificial Intelligence (AI) engine, wherein the prompt is generated to comprise a predefined structure of a static portion and a dynamic portion, wherein the dynamic portion is configured to be populated with the source data every invocation of the trigger event;
providing the prompt to the AI engine; and
obtaining the result from the AI engine based on the prompt, wherein the output is determined based on the result from the AI engine.

3. The method of claim 2, wherein the automation process is configured to be executed with respect to a content source, wherein the content source comprises a database or a repository, wherein the prompt to the AI engine is determined to be generated at least in part based on retrieved data that is retrieved from the content source.

4. The method of claim 2, wherein the AI engine comprises a Large Language Model (LLM) or a Small Language Model (SLM).

5. The method of claim 1, wherein the page context comprises at least one of:
an element in the GUI;
an address of a page rendering the GUI, wherein the address of the page comprises a Uniform Resource Locator (URL);
a user segment of an end user;
the text in the GUI;
a user interaction with the text presented in the GUI; and
one or more properties of the GUI.

6. The method of claim 5, wherein the one or more properties comprise a first property of a first GUI element in the GUI, and a second property of a second GUI element in the GUI, wherein the one or more conditions define a logical relationship between the first and second properties.

7. The method of claim 1 further comprising determining compliance with the one or more conditions of the identification event based on a second automation process, said determining the compliance comprising:
automatically processing the text by an execution of the second automation process;
based on said automatically processing, determining whether the text complies with the one or more conditions; and
presenting the launcher in the software assistant based on said determining that the text complies with the one or more conditions.

8. The method of claim 7, wherein the compliance is determined based on a semantic analysis of the text, wherein the semantic analysis of the text is performed, as part of the second automation process, using a language model.

9. The method of claim 8, wherein the one or more conditions require that the GUI represents a specific form, wherein the semantic analysis is configured to determine whether the GUI represents the specific form.

10. The method of claim 1 further comprising removing the launcher from the software assistant in response to a determination that the GUI of the third-party application no longer complies with the one or more conditions of the identification event.

11. The method of claim 1, wherein the launcher comprises a GUI control, wherein the trigger event associated with the launcher comprises a user interaction with the GUI control when presented in a bar of the software assistant.

12. The method of claim 1, wherein the source data comprises at least one of:
text associated to at least one element that is rendered in the GUI;
selected text in the GUI and is selected by an end user; and
all text that is rendered in the GUI.

13. The method of claim 12, wherein the source data comprises text associated to the at least one element, wherein the launcher and the output are not presented adjacently to the at least one element.

14. The method of claim 1, wherein the software assistant is configured to present a second launcher over the GUI in response to the identification event, the second launcher defines a second automation process different than the first automation process.

15. The method of claim 1 further comprising:
defining a second identification event configured to cause a second launcher to be displayed within a bar of the software assistant, the second identification event different from the identification event;
defining second source data for the second launcher;
configuring the software assistant to present the second launcher within the bar in response to the second identification event; and
configuring the software assistant to, in response to a second trigger event of the second launcher, execute a second automation process, wherein an execution of the second automation process processes the second source data and outputs a second result, the second automation process is different from the automation process.

16. The method of claim 1, wherein the software assistant is a copilot, the copilot configured to present a chat widget as part of a natural language conversation with the end user, the copilot configured to present a bar widget with one or more launchers in response to one or more identification events, respectively, the one or more identification events comprise at least the identification event.

17. The method of claim 16, wherein the bar widget is configured to be visible for a defined timeframe after the occurrence of the identification event, wherein the bar widget is configured to become invisible after the defined timeframe.

18. The method of claim 16, wherein the configuration for presenting the output comprises presenting the output via the chat widget of the copilot.

19. The method of claim 1 further comprising: configuring the software assistant to, in response to the occurrence of the trigger event, automatically execute a plurality of automatic processes that are configured to process a respective plurality of data sources from the text, thereby obtaining a respective plurality of outputs.

20. The method of claim 19, further comprising defining a second configuration for presenting the plurality of outputs in the GUI, wherein the second configuration comprises presenting a set of tags in a window overlay, the window overlay is overlayed over the third-party application, each tag corresponding to a respective automation process from the plurality of automatic processes, wherein the window overlay is configured to present, for a tag, a generated output of a respective automation process of the tag, wherein the generated output is configured to be presented together with the tag in a separate section of the window overlay, or in an output section of the window overlay in response to a selection of the tag from the set of tags.

21. The method of claim 20, wherein the window overlay is configured to depict a highlight control for the tag, wherein selecting the highlight control causes a data source of the tag to be highlighted in the GUI.

22. The method of claim 1, wherein there is no Application Programming Interface (API) between the software assistant and the third-party application, wherein the software assistant is configured to identify the identification event by monitoring and analyzing the GUI of the third-party application as rendered on an end device of the plurality of end devices.

23. The method of claim 1, wherein said configuring the software assistant is performed by an administrator user using a digital adoption platform, the digital adoption platform is agnostic to the third-party application, wherein the digital adoption platform is configured to assist the end users with performing digital tasks on the third-party application.

24. A method comprising:
assisting an end user with performing a digital task associated with a Graphical User Interface (GUI) of a third-party application, the end user is executing the third-party application on an end device, said assisting comprises:
executing an assistance layer on the end device, the assistance layer comprises a software assistant;
presenting a launcher in a bar widget of the software assistant, said presenting is performed in response to the assistance layer detecting an occurrence of an identification event in the GUI;
executing an automation process of the launcher on the end device, said executing the automation process is performed in response to identifying an interaction of the end user with the launcher via the bar widget; and
presenting an output over the GUI to the end user, the output is determined based on a result from the automation process, the output is presented in a chat widget of the software assistant.

25. The method of claim 24, wherein there is no Application Programming Interface (API) between the software assistant and the third-party application, wherein the software assistant is configured to identify the identification event by monitoring and analyzing the GUI of the third-party application as rendered on the end device.

26. An apparatus comprising a processor and a memory, the processor adapted to configure a software assistant, the software assistant is configured to be executed as an overlay over a third-party application, the third-party application is executable on a plurality of end devices of end users, the processor is adapted to:
define an identification event associated with a Graphical User Interface (GUI) of the third-party application, the identification event is defined based on one or more conditions associated with a page context of the GUI;
define that, in response to an occurrence of the identification event, a launcher associated with an automation process is configured to be automatically presented in the software assistant over the GUI;
define source data associated with the automation process, the source data comprising at least a portion of text presented in the GUI, wherein the automation process is configured to process the source data;
configure the software assistant to, in response to an occurrence of a trigger event associated with the launcher, automatically execute the automatic process, the automatic process is configured to process the source data and output a result; and
defining a configuration for presenting an output in the GUI, the output is determined based on the result of the automation process.

27. The apparatus of claim 25, wherein the automation process comprises:
automatically generating a prompt for an Artificial Intelligence (AI) engine, wherein the prompt is generated to comprise a predefined structure of a static portion and a dynamic portion, wherein the dynamic portion is configured to be populated with the source data every invocation of the trigger event;
providing the prompt to the AI engine; and
obtaining the result from the AI engine based on the prompt, wherein the output is determined based on the result from the AI engine.

28. A computer program product comprising a non-transitory computer readable storage medium retaining program instructions, which program instructions when read by a processor, cause the processor to:
assist an end user with performing a digital task associated with a Graphical User Interface (GUI) of a third-party application, the end user is executing the third-party application on an end device, said assisting comprises:
executing an assistance layer on the end device, the assistance layer comprises a software assistant;
presenting a launcher in a bar widget of the software assistant, said presenting is performed in response to the assistance layer detecting an occurrence of an identification event in the GUI,
executing an automation process of the launcher on the end device, said executing the automation process is performed in response to identifying an interaction of the end user with the launcher via the bar widget; and
presenting an output over the GUI to the end user, the output is determined based on a result from the automation process, the output is presented in a chat widget of the software assistant.
